(19) United States
(12) Patent Application Publication
(10) Pub. No.: US 2026/0148444 A1
(43) Pub. Date: May 28, 2026

(54) SUBJECT DRIVEN IMAGE EDITING

(71) Applicant: ADOBE INC., SAN JOSE, CA (US)

(72) Inventors: Yilin Wang, Sunnyvale, CA (US); Jing Gu, Santa Clara, CA (US); Nanxuan Zhao, San Jose, CA (US); Wei Xiong, San Jose, CA (US); Qing Liu, Santa Clara, CA (US); Zhifei Zhang, San Jose, CA (US); He Zhang, Santa Clara, CA (US); Jianming Zhang, Cupertino, CA (US); Hyun Joon Jung, Monte Sereno, CA (US)

(21) Appl. No.: 18/957,772

(22) Filed: Nov. 24, 2024

(51) Int. Cl. G06T 11/60

(52) U.S. Cl. CPC G06T 11/60

(57) ABSTRACT

A method, apparatus, non-transitory computer readable medium, and system for image generation include obtaining a concept input, a source image, and an input mask, where the concept input represents a concept, the source image depicts a scene, and the input mask indicates a location for the concept in the scene. Concept features are generated by performing a style transfer from the source image to the concept input based on the input mask. A synthetic image is generated, using an image generation model, based on the concept features. The synthetic image depicts the concept from the concept input within the scene from the source image at the location indicated by the input mask.

### BACKGROUND

The following relates generally to image processing, and more specifically to image generation using machine learning. Digital image processing refers to the use of a computer to edit a digital image using an algorithm or a processing network. In some cases, image processing software can be used for various tasks, such as image editing, image restoration, image generation, etc. Recently, machine learning models have been used in advanced image processing techniques. Among these machine learning models, diffusion models and other generative models such as generative adversarial networks (GANs) have been used for various tasks including generating images with perceptual metrics, generating images in conditional settings, image inpainting, and image manipulation.

Image generation, a subfield of image processing, involves the use of diffusion models to synthesize images. Diffusion models can be used for various image generation tasks including image super-resolution, generation of images with perceptual metrics, conditional generation (e.g., generation based on text guidance), image inpainting, and image manipulation. Specifically, diffusion models are trained to take random noise as input and generate unseen images with features similar to the training data.

### SUMMARY

The present disclosure describes systems and methods for image generation. Embodiments of the present disclosure include an image generation apparatus that obtains a concept input, a source image and an input mask and swaps a concept/object from the concept input into the source image at a target location. The input mask indicates the target location for the concept in the scene of the source image. The image generation apparatus generates concept features (e.g., foreground features based on the concept input) by performing a style transfer from the source image to the concept input based on the input mask. The image generation apparatus generates a synthetic image based on the concept features. In some examples, the synthetic image preserves a cohesive style by adapting the concept into the source image at the target location in a visually consistent manner.

A method, apparatus, non-transitory computer readable medium, and system for image generation are described. One or more embodiments of the method, apparatus, non-transitory computer readable medium, and system include obtaining a concept input, a source image, and an input mask, wherein the concept input represents a concept, the source image depicts a scene, and the input mask indicates a location for the concept in the scene; generating concept features by performing a style transfer from the source image to the concept input based on the input mask; and generating, using an image generation model, a synthetic image based on the concept features, wherein the synthetic image depicts the concept from the concept input within the scene from the source image at the location indicated by the input mask.

A method, apparatus, non-transitory computer readable medium, and system for image generation are described. One or more embodiments of the method, apparatus, non-transitory computer readable medium, and system include obtaining a concept input and a source image, wherein the concept input represents a concept and the source image depicts a scene; generating concept features based on the concept input and the source image by performing a style transfer from the source image; generating background features based on the source image; and generating, using an image generation model, a synthetic image based on the concept features and the background features, wherein the synthetic image depicts the concept from the concept input within the scene from the source image.

An apparatus, system, and method for image generation are described. One or more embodiments of the apparatus, system, and method include a memory component; a processing device coupled to the memory component, the processing device configured to perform operations comprising; obtaining a concept input, a source image, and an input mask, wherein the concept input represents a concept, the source image depicts a scene, and the input mask indicates a location for the concept in the scene; generating concept features by performing a style transfer from the source image to the concept input based on the input mask; and generating, using an image generation model, a synthetic image based on the concept features, wherein the synthetic image depicts the concept from the concept input within the scene from the source image at the location indicated by the input mask.

### BRIEF DESCRIPTION OF THE DRAWINGS

FIG. 1 shows an example of an image generation system according to aspects of the present disclosure.

FIG. 2 shows an example of a method for conditional media generation according to aspects of the present disclosure.

FIG. 3 shows an example of object swapping according to aspects of the present disclosure.

FIG. 4 shows an example of partial object swapping according to aspects of the present disclosure.

FIGS. 5 and 6 show examples of multi-object swapping according to aspects of the present disclosure.

FIGS. 7 and 8 show examples of cross-domain object swapping according to aspects of the present disclosure.

FIG. 9 shows an example of text-based swapping according to aspects of the present disclosure.

FIG. 10 shows an example of object insertion according to aspects of the present disclosure.

FIG. 11 shows an example of a method for image generation according to aspects of the present disclosure.

FIG. 12 shows an example of an image generation apparatus according to aspects of the present disclosure.

FIGS. 13 and 14 show examples of an image generation model according to aspects of the present disclosure.

FIG. 15 shows an example of targeted variable manipulation in a diffusion process according to aspects of the present disclosure.

FIG. 16 shows an example of correspondence between a latent feature and a synthetic image according to aspects of the present disclosure.

FIG. 17 shows an example of a guided diffusion model according to aspects of the present disclosure.

FIG. 18 shows an example of a U-Net architecture according to aspects of the present disclosure.

FIG. 19 shows an example of a diffusion process according to aspects of the present disclosure.

FIGS. 20 and 21 show examples of methods for image generation according to aspects of the present disclosure.

FIGS. 22 and 23 show examples of evaluation according to aspects of the present disclosure.

FIG. 24 shows an example of a method for training a diffusion model according to aspects of the present disclosure.

FIG. 25 shows an example of a step-by-step procedure for training a machine learning model according to aspects of the present disclosure.

FIG. 26 shows an example of a computing device for image processing according to aspects of the present disclosure.

### DETAILED DESCRIPTION

The present disclosure describes systems and methods for image generation. Embodiments of the present disclosure include an image generation apparatus that obtains a concept input, a source image and an input mask and swaps a concept/object from the concept input into the source image at a target location. A concept can include an object, an icon, a design, a pattern, a logo, a shape, a texture a style or any other semantic concept that can be depicted in an image. In some examples, the concept is an object with a recognizable shape. In other cases, the concept is the shape itself. The concept input can include an image depicting the concept or text describing the concept.

The input mask indicates the target location for the concept in the scene of the source image. The image generation apparatus generates concept features (e.g., foreground features based on the concept input) by performing a style transfer from the source image to the concept input based on the input mask. The image generation apparatus generates a synthetic image based on the concept features. In some examples, the synthetic image preserves a cohesive style by adapting the concept into the source image at the target location in a visually consistent manner.

Diffusion models are a class of generative neural networks that can be trained to generate new data with features similar to features found in training data. Diffusion models can be used in image synthesis, image completion tasks, etc. Conventional models are designed to perform object swapping and replacement by changing intermediate variables affecting the object's features. However, conventional models lack the precision sufficient for localized object swapping, resulting in unsatisfactory visual qualities. Therefore, conventional models are not able to swap a concept/object into an image while preserving the style and consistency of the image (i.e., fall short of harmonious object transition).

Embodiments of the present disclosure include an image generation apparatus that receive a concept input, a source image, and an input mask as inputs and perform object swapping. The concept input represents a concept, the source image depicts a scene, and the input mask indicates a location for the concept in the scene. The image generation apparatus generates concept features by performing a style transfer from the source image to the concept input based on the input mask. In some examples, an image generation model (e.g., a diffusion model) generates a synthetic image based on the concept features. The synthetic image depicts the concept from the concept input within the scene from the source image at the location indicated by the input mask.

In some embodiments, the image generation model enables the swapping of one or more objects in a source image with personalized concept from a concept input, while maintaining the context of the source image. The image generation model has precise control of arbitrary objects and parts to be swapped out or replaced and can preserve context pixels. The personalized concept is adapted to the source image to obtain a synthetic image. The image generation model applies a combination of targeted variable swapping and appearance adaptation process. In some examples, targeted variable swapping enforces region control over latent feature maps and makes sure to swap masked variables for faithful context preservation and initial semantic concept swapping.

Subsequently, the appearance adaptation process, via a location adaptation module, a style adaptation module (including an instance normalization component), a scale adaptation module, and a content adaptation module, seamlessly adapts the semantic concept into the source image in terms of target location, shape, style, and content during the image generation process. One or more embodiments provide personalized swapping by making precise and specific swaps across various swapping tasks such as single object swapping, multiple objects swapping, partial object swapping, and cross-domain swapping. In some cases, the image generation model obtains a text prompt describing an element of the source image and performs text-based swapping and object insertion.

In some embodiments, the image generation model uses a pre-trained diffusion model to perform personalized arbitrary object swapping while enabling context pixel preservation and harmonious object transition. Variables in the diffusion process (e.g., latent features from a U-Net) have a correspondent relation with the source image. The image generation model, based on the latent-feature-and-image correspondence, is designed to keep the context pixels in the source image by preserving the correspondent part of those variables in the swapping process. The image generation model can precisely swap specific areas, ensuring the preservation of other objects and the background's integrity in the source image.

In some examples, the object information in the source image is selected for appearance adaptation. Location adaptation, via a location adaptation module, controls the location where the new concept should be swapped. Style adaptation, via a style adaptation module, ensures stylistic harmony between the concept/object and the source (original) image, fostering a natural and cohesive visual presentation. Scale adaptation, via a scale adaptation module, modulates the target object's shape and size, ensuring its congruence with the spatial and dimensional aspects of the source image. Furthermore, content adaptation, via a content adaptation module, smoothly generates the new concept, enabling a seamless blend that mitigates artifacts or unnatural transitions.

The present disclosure describes systems and methods that improve on conventional image generation models by increasing the accuracy of a concept/object generated in a synthesized image. For example, users can use the image generation model described in the present disclosure to swap a concept (e.g., a shield) into a source image depicting a turtle at a target location indicated by an input mask (e.g., around the hard shell of the turtle). Embodiments of the present disclosure achieve this increased accuracy by identifying key variables for content preservation and perform targeted swapping for background preservation. Additionally, the appearance adaptation process (a combination of location adaptation, style adaptation, scale adaptation, and content adaptation) is used to adapt the concept into the source image. With specialized adaptations, the image generation model provides a heightened level of precision and refinement in the field of image editing and object swapping.

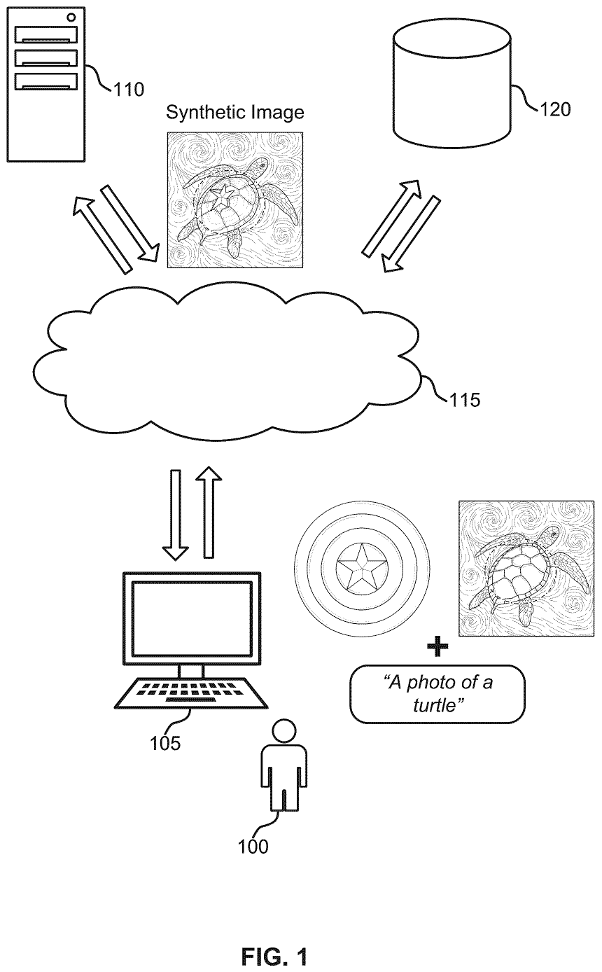

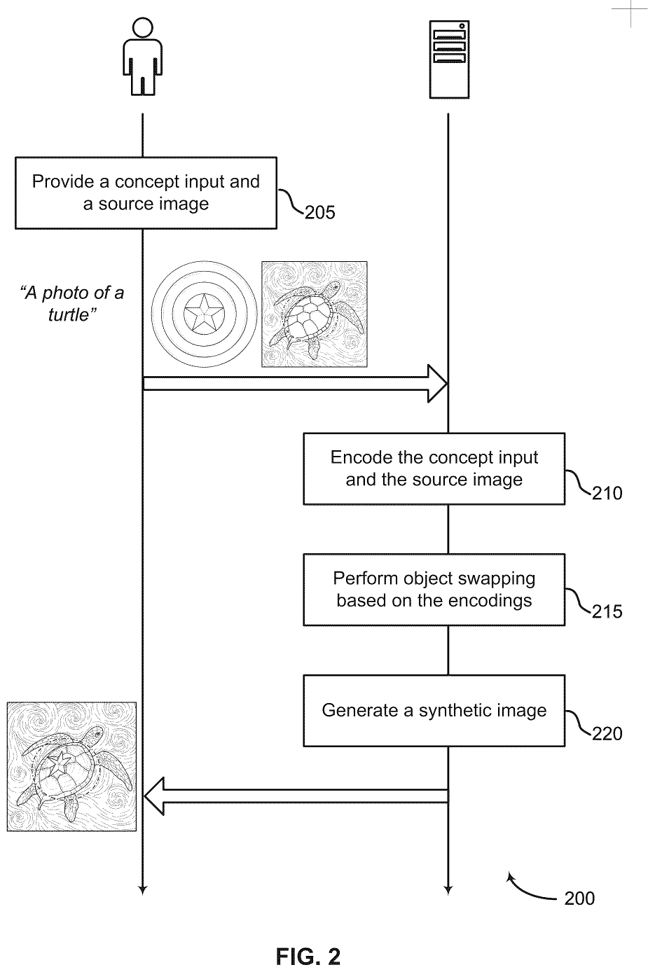

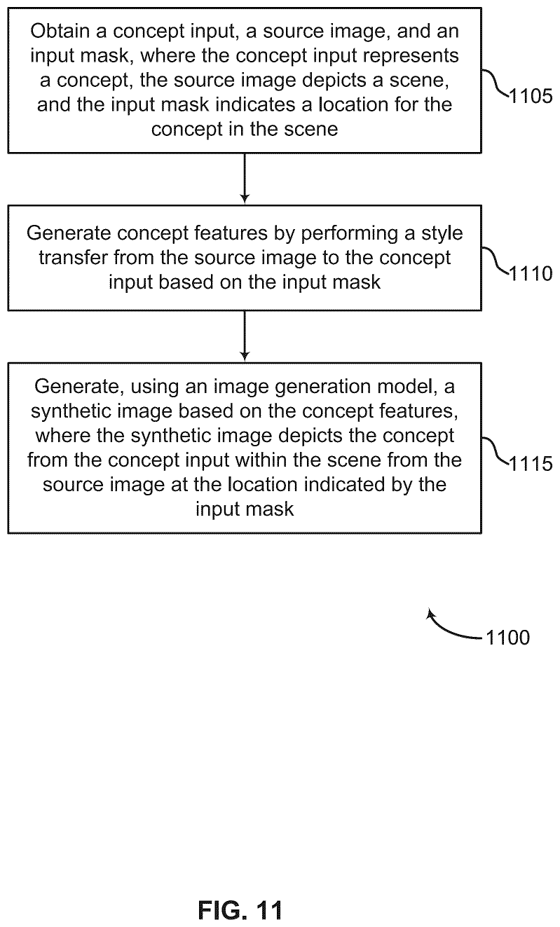

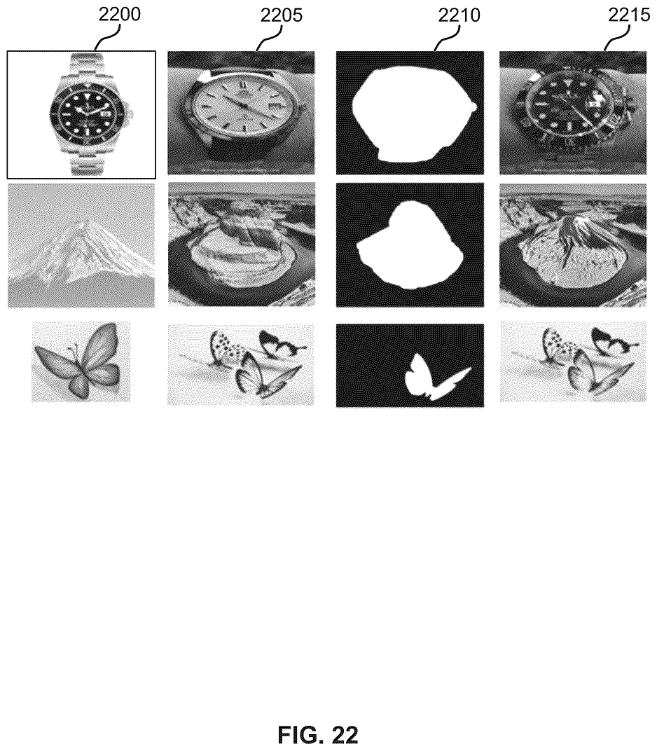

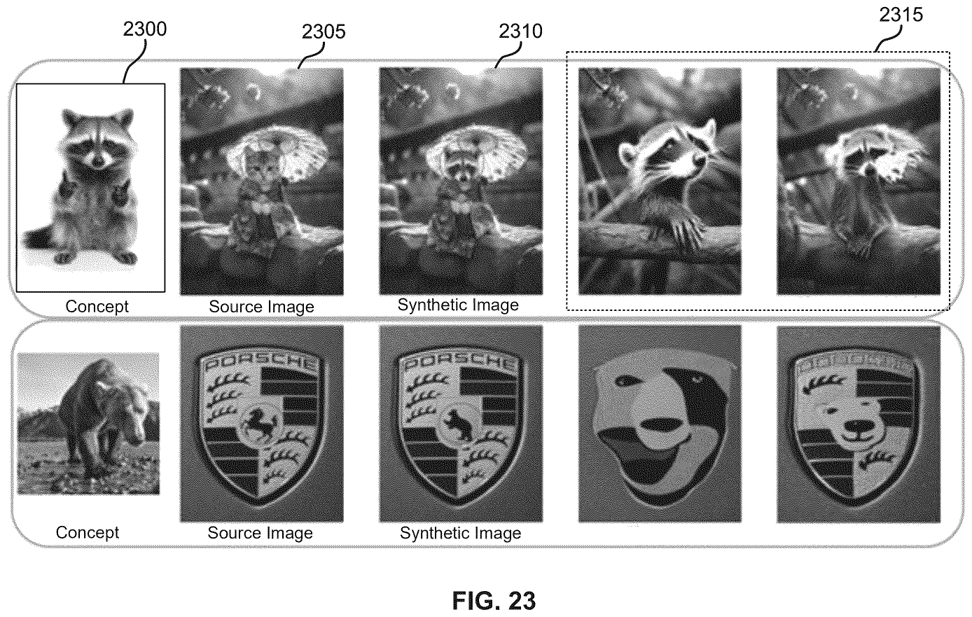

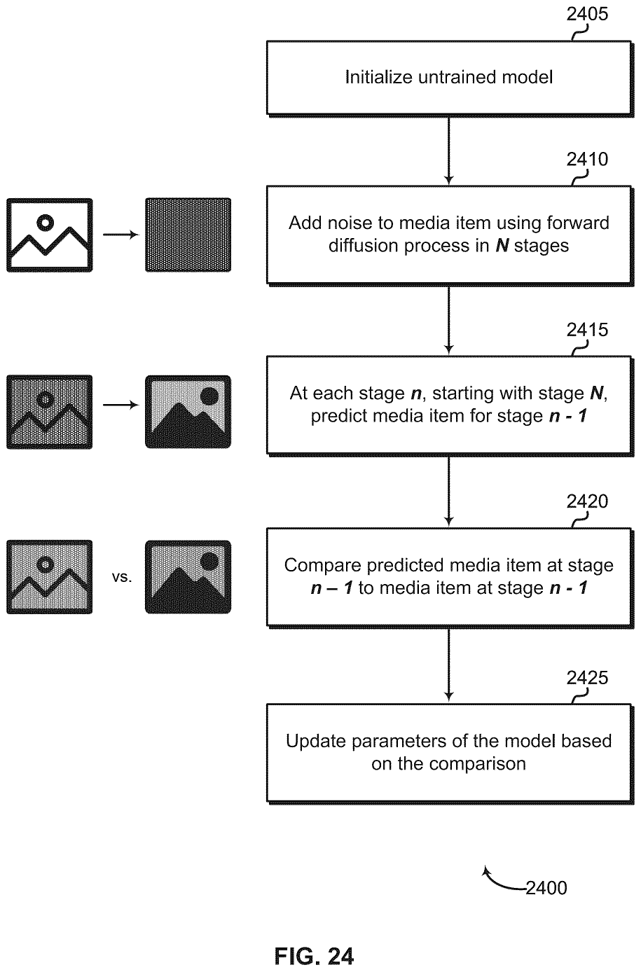

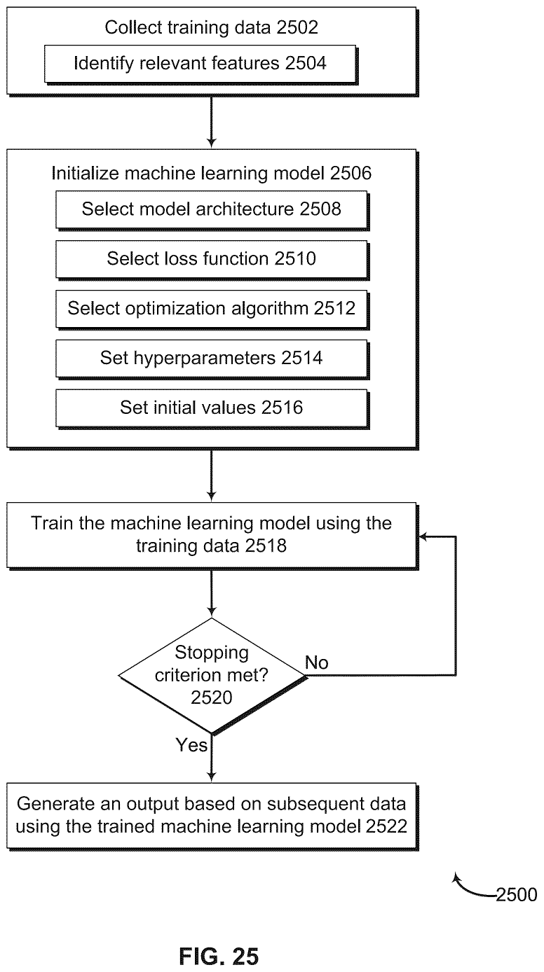

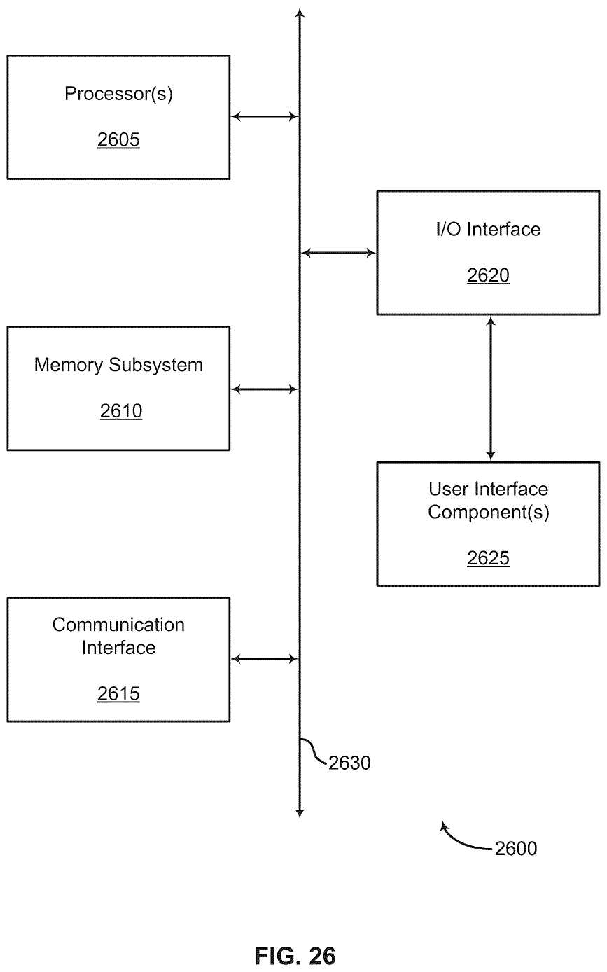

Embodiments of the present disclosure have applications in personalized swapping and text-based swapping on a single object, multiple objects, partial object, and cross-domain object. Embodiments of the present disclosure can be applied to other tasks such as object insertion. Examples of application in image generation context are provided with reference to FIGS. 2-7. Details regarding the architecture of an example image generation system are provided with reference to FIGS. 1 and 12-19. Details regarding the image generation process are provided with reference to FIGS. 11 and 20-21. Details regarding the evaluation and model comparison are provided with reference to FIGS. 22-23. Details regarding an example of training a machine learning model are provided with reference to FIGS. 24-25. Details regarding a computing device for image processing are provided with reference to FIG. 26.

### Image Generation Process

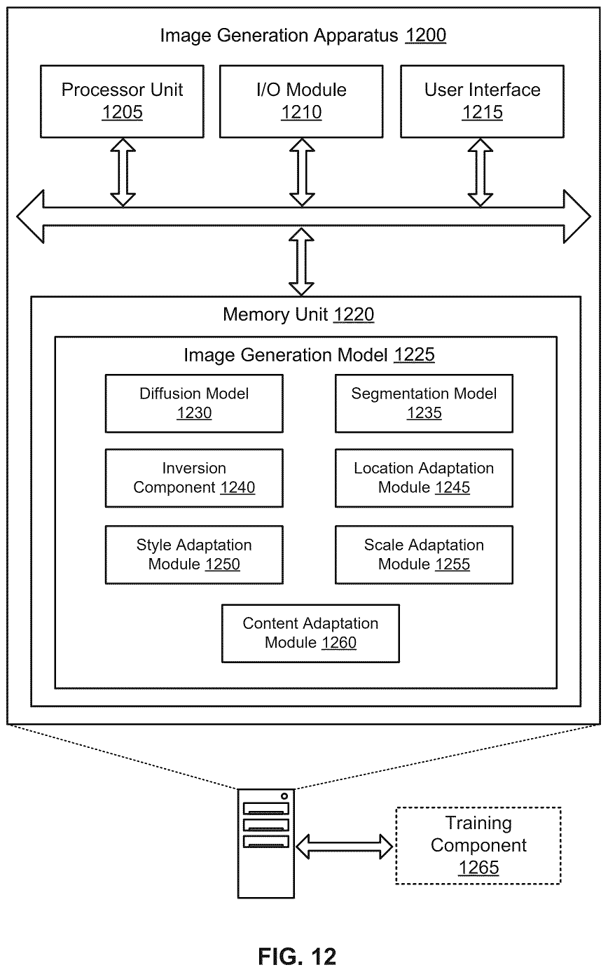

FIG. 1 shows an example of an image generation system according to aspects of the present disclosure. The example shown includes user 100, user device 105, image generation apparatus 110, cloud 115, and database 120. Image generation apparatus 110 is an example of, or includes aspects of, the corresponding element described with reference to FIG. 12.

In an example shown in FIG. 1, a concept input, a source image, and a text prompt are provided by user 100. The concept input represents a concept, the source image depicts a scene, and the text prompt describes an element of the source image. In some cases, the input mask is generated based on the source image and the text prompt. The input mask is based on a region of the element described by the text prompt. The input mask indicates a location for the concept in the scene. For example, the concept input describes a shield with a star shape in the center of the shield. The source image depicts a turtle swimming in a current. The text prompt is “A photo of a turtle”. The concept input, the source image, the text prompt, and the input mask are transmitted to image generation apparatus 110, e.g., via user device 105 and cloud 115.

Image generation apparatus 110 generates concept features by performing a style transfer from the source image to the concept input based on the input mask. Image generation apparatus 110 generates, using an image generation model, a synthetic image based on the concept features. The synthetic image depicts the concept from the concept input within the scene from the source image at the location indicated by the input mask. For example, the shield is swapped into the source image at the location of the turtle's hard shell. Image generation apparatus 110 returns a synthetic image to user 100 via cloud 115 and user device 105. The synthetic image depicts the same scene (e.g., a turtle swimming in a current) and includes a shield that replaces the turtle's hard shell.

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator, an image editing tool). In some examples, the image processing application on user device 105 may include functions of image generation apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

Image generation apparatus 110 includes a computer-implemented network comprising a diffusion model, a segmentation model, an inversion component, a location adaptation module, a style adaptation module (including an instance normalization component), a scale adaptation module, and a content adaptation module. Image generation apparatus 110 may also include a processor unit, a memory unit, an I/O module, and a user interface. A training component may be implemented on an apparatus other than image generation apparatus 110. The training component is used to train a machine learning model. Additionally, image generation apparatus 110 can communicate with database 120 via cloud 115. In some cases, the architecture of the image generation network is also referred to as a network, a machine learning model, or a network model. Further detail regarding the architecture of image generation apparatus 110 is provided with reference to FIGS. 12-19. Further detail regarding the operation of image generation apparatus 110 is provided with reference to FIGS. 2, 11 and 20-21.

In some cases, image generation apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., dataset for training an image generation model) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

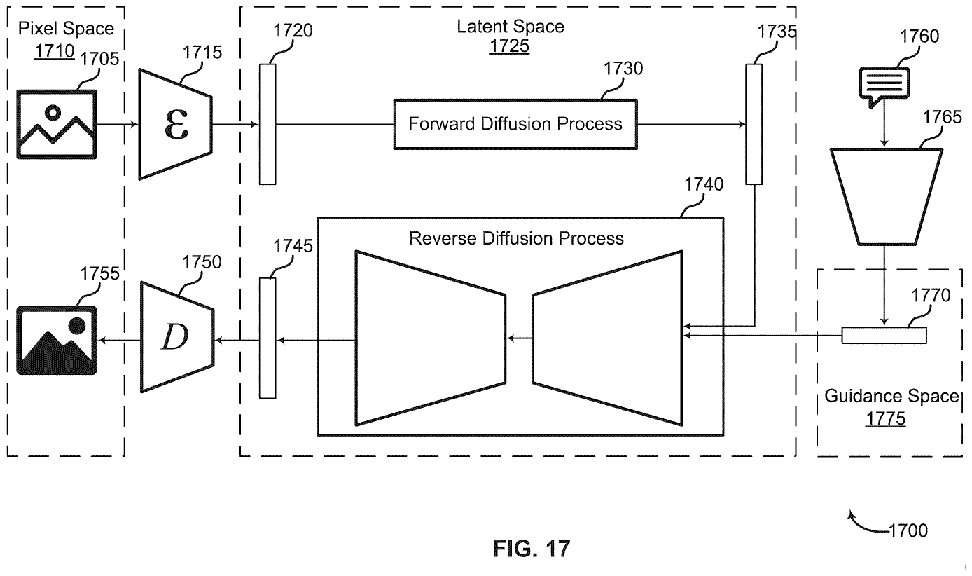

FIG. 2 shows an example of a method 200 for conditional media generation according to aspects of the present disclosure. In some examples, method 200 describes an operation of the image generation model 1225 described with reference to FIG. 12 such as an application of the guided latent diffusion model 1700 described with reference to FIG. 17. The method 200 is performed by user 100 interacting with image generation apparatus 110 via user device 105 as described with reference to FIG. 1. In some examples, these operations are performed by a system including a processor executing a set of codes to control functional elements of an apparatus such as the image generation apparatus described in FIGS. 1 and 12.

Additionally or alternatively, steps of the method 200 may be performed using special-purpose hardware. Generally, these operations are performed according to the methods and processes described in accordance with aspects of the present disclosure. In some cases, the operations described herein are composed of various substeps or are performed in conjunction with other operations.

At operation 205, the user provides a concept input and a source image. In some cases, the operations of this step refer to, or may be performed by, a user as described with reference to FIG. 1. In an example shown in FIG. 2, a concept input represents a shield with stripes and a star at its center. A source image depicts an artistic representation of a turtle swimming in swirling water. In some cases, the concept input includes one or more concept objects to be swapped into the source image at different regions. Additionally, the user provides a text prompt (“A photo of a turtle”) describing an element of the source image.

At operation 210, the system encodes the concept input and the source image. In some cases, the operations of this step refer to, or may be performed by, an image generation apparatus as described with reference to FIGS. 1 and 12. In some cases, the concept input is converted into an embedding space (e.g., represented by token(s)). The source image is inverted to a noise map (or a latent noise encoding). In some examples, the noise map contains U-Net variables, including latent features, attention map, and attention output.

At operation 215, the system performs object swapping based on the encodings. In some cases, the operations of this step refer to, or may be performed by, an image generation apparatus as described with reference to FIGS. 1 and 12. In some cases, the object from the concept input is adapted harmoniously into the source image by adjusting several aspects of the concept, such as location, style, scale, content, etc. In some examples, an input mask (indicates a location for the concept in the scene) provides information relevant to the location to swap the concept/object into the source image. If there are multiple concepts in the concept input, the system can swap the multiple concepts into a source image.

At operation 220, the system generates a synthetic image. In some cases, the operations of this step refer to, or may be performed by, an image generation apparatus as described with reference to FIGS. 1 and 12. In some cases, a pre-trained diffusion model generates the synthetic image based on the concept input, the source image, and the text prompt. The synthetic image depicts an object from the concept image harmoniously swapped into the scene of the source image. In the above example, the synthetic image depicts the artistic representation of a turtle from source image, and the shield from concept input, after object swapping, is harmoniously swapped into the shell of the turtle (or replaces the shell). The shield is adapted to match the style and context of the source image. The desired location for the shield to be swapped (i.e., shell of the turtle) is identified by the input mask (target region).

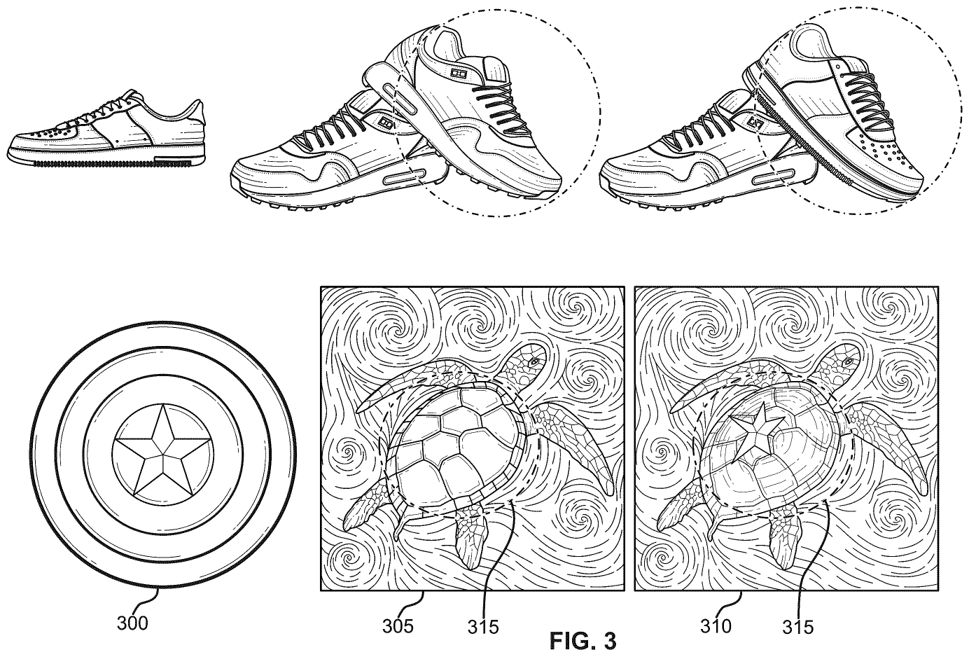

FIG. 3 shows an example of object swapping according to aspects of the present disclosure. The example shown includes concept input 300, source image 305, synthetic image 310, and target region 315. As illustrated in FIG. 3, an image generation model (as described with reference to FIGS. 12-14) takes a concept input 300 and a source image 305 as inputs and generates a synthetic image 310 which swaps an object from concept input 300 harmoniously into source image 305. In some cases, the object is swapped into the source image 305 at a location identified by target region 315. The target region 315 provides information relating to the location and scale of the swapped object. In some cases, the object from concept input 300 is partially swapped into the source image 305 so as to preserve the style and content of source image 305.

In one example, concept input 300 represents a shield with stripes and a star at its center. Source image 305 depicts an artistic representation of a turtle swimming in swirling water. The image generation model takes these as inputs and generates synthetic image 310, which depicts the artistic representation of a turtle from source image 305, and the shield from concept input 300, after object swapping, is harmoniously swapped into the shell of the turtle. The shield is adapted to match the style and context of the source image 305. The location for the shield to be swapped (i.e., shell of the turtle) is identified by target region 315.

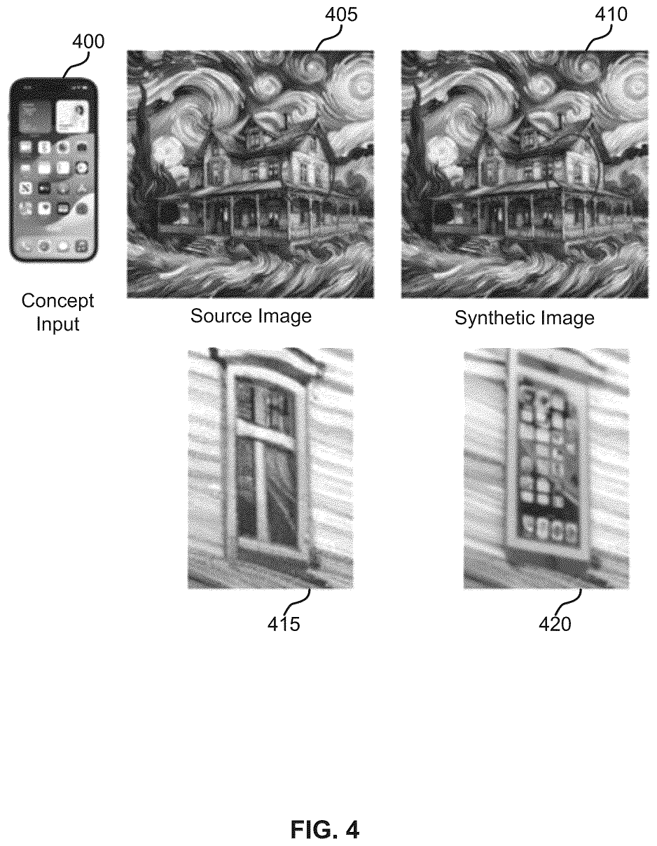

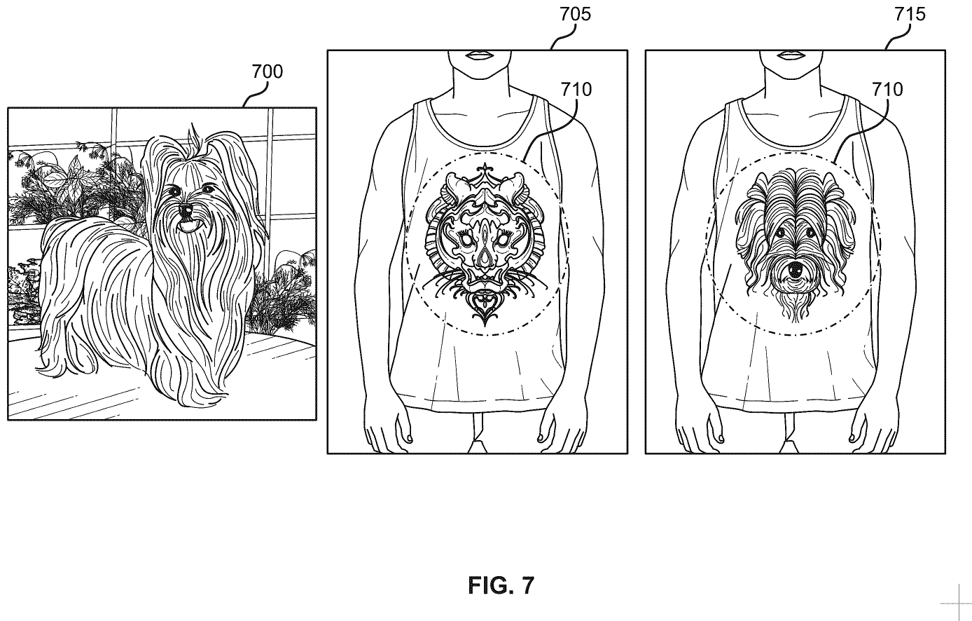

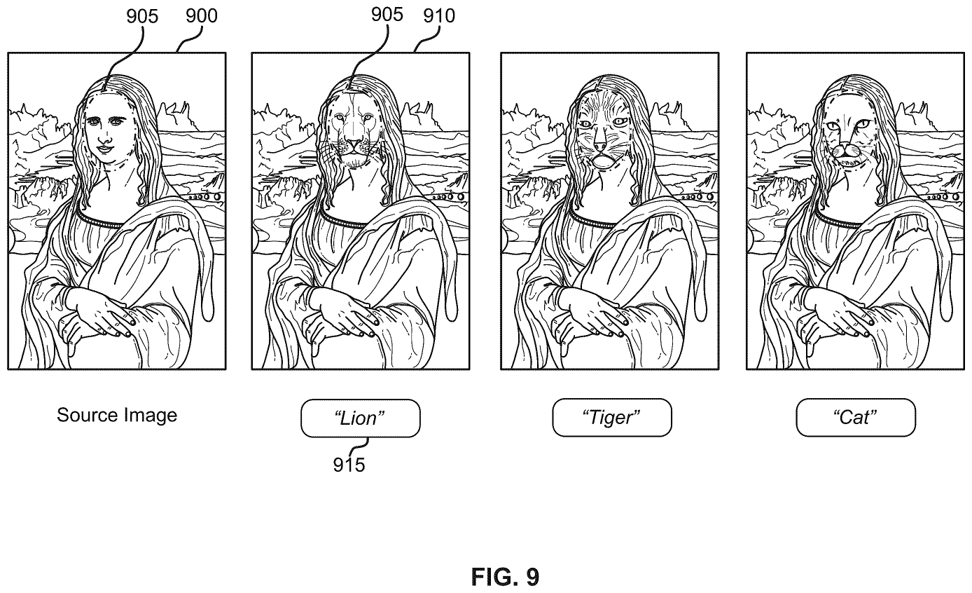

Concept input 300 is an example of, or includes aspects of, the corresponding element described with reference to FIGS. 4, 7, 8, 10, 13, 14, 22, and 23. Source image 305 is an example of, or includes aspects of, the corresponding element described with reference to FIGS. 4, 6-10, 13, 14, 22, and 23. Synthetic image 310 is an example of, or includes aspects of, the corresponding element described with reference to FIGS. 4, 7-10, 13, 14, 16, 22, and 23. Target region 315 is an example of, or includes aspects of, the corresponding element described with reference to FIGS. 7 and 9.

FIG. 4 shows an example of partial object swapping according to aspects of the present disclosure. The example shown includes concept input 400, source image 405, synthetic image 410, original region 415, and modified region 420. As illustrated in FIG. 4, a partial object swap is performed on a relatively small area of source image 405 using an image generation model (as described with reference to FIGS. 12-14). In an example illustrated in FIG. 4, an object from concept input 400 (a smartphone) is swapped into source image 405 (depicting a house) to generate synthetic image 410, where the smartphone is swapped into the house at original region 415 (a window of the house in source image 405). Modified region 420 of synthetic image 410 depicts a smartphone adapted into the window of the house. Synthetic image 410 and modified region 420 preserve the style and context of source image 405 while swapping in the smartphone object from concept input 400.

Concept input 400 is an example of, or includes aspects of, the corresponding element described with reference to FIGS. 3, 7, 8, 10, 13, 14, 22, and 23. Source image 405 is an example of, or includes aspects of, the corresponding element described with reference to FIGS. 3, 6-10, 13, 14, 22, and 23. Synthetic image 410 is an example of, or includes aspects of, the corresponding element described with reference to FIGS. 3, 7-10, 13, 14, 16, 22, and 23.

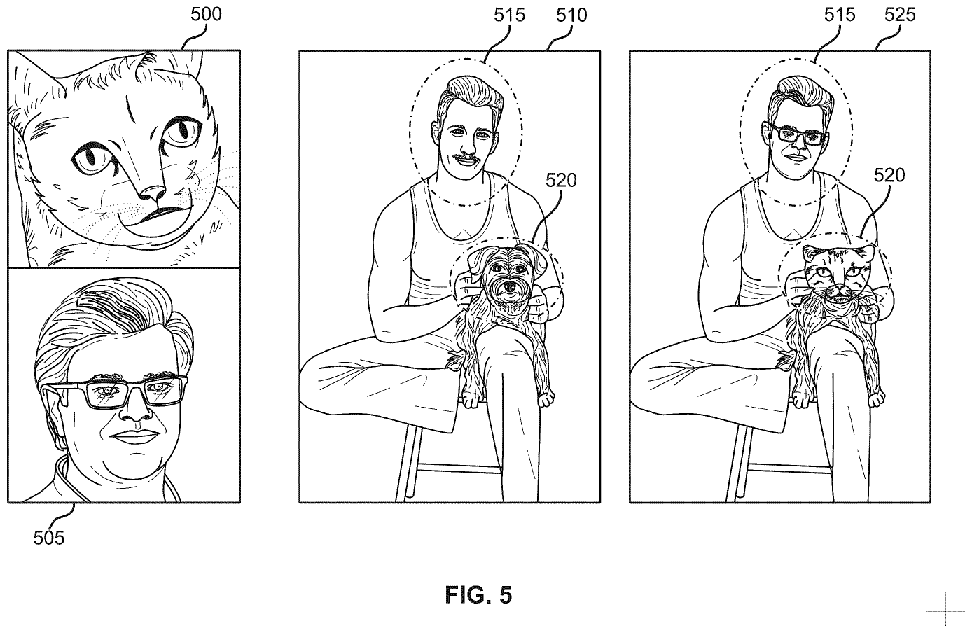

FIG. 5 shows an example of multi-object swapping according to aspects of the present disclosure. The example shown includes first concept input 500, second concept input 505, source image 510, and synthetic image 525. In one example, source image 510 includes first region 515 and second region 520. As illustrated in FIG. 5, synthetic image 525 includes two swapped-in objects at first region 515 and second region 520, respectively. In this example, first concept input 500 and second concept input 505 represent a cat and a man's face, respectively. Source image 510 depicts one or more other elements, a background, and a scene, e.g., a man holding a dog. The objects from first concept input 500 and second concept input 505 are swapped into source image 510 at first region 515 and second region 520, respectively. An image generation model (as described with reference to FIGS. 12-14) generates synthetic image 525 based on first concept input 500, second concept input 505, and source image 510. The swapped objects in synthetic image 525 are adapted to preserve the style and context of source image 510. In some cases, multiple objects are swapped into source image 510 by repeating single-object swapping for each of the multiple objects.

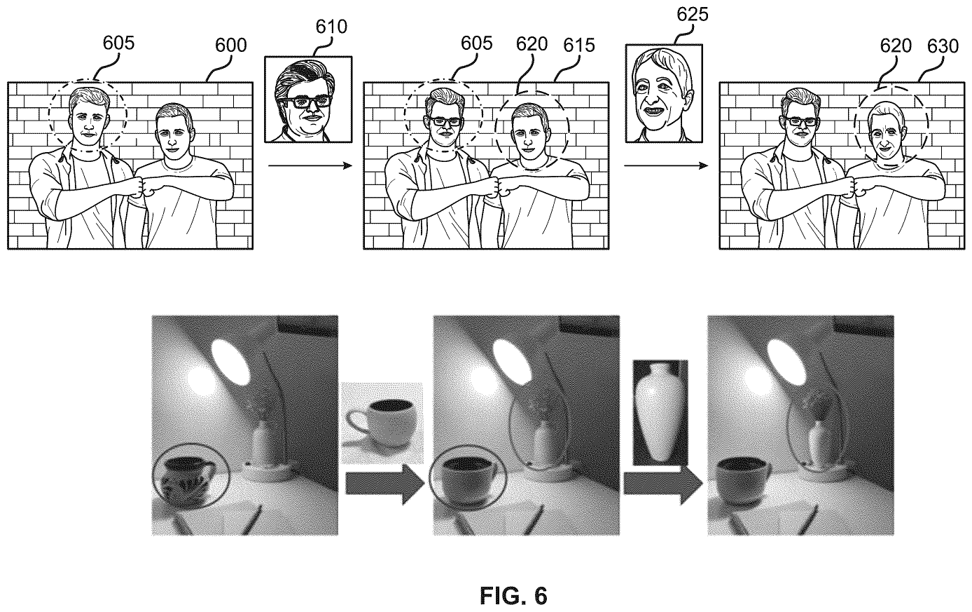

First concept input 500 is an example of, or includes aspects of, the corresponding element described with reference to FIG. 6. Second concept input 505 is an example of, or includes aspects of, the corresponding element described with reference to FIG. 6. Source image 510 is an example of, or includes aspects of, the corresponding element described with reference to FIGS. 3-4. First region 515 is an example of, or includes aspects of, the corresponding element described with reference to FIG. 6. Second region 520 is an example of, or includes aspects of, the corresponding element described with reference to FIG. 6. Synthetic image 525 is an example of, or includes aspects of, the corresponding element described with reference to FIG. 3-4.

FIG. 6 shows an example of multi-object swapping according to aspects of the present disclosure. The example shown includes source image 600, first region 605, first concept input 610, first synthetic image 615, second region 620, second concept input 625, and second synthetic image 630. As illustrated in FIG. 6, multi-object swapping is implemented by swapping one object at a time using an image generation model (as described with reference to FIGS. 12-14). In one example, first synthetic image 615 depicts an object from first concept input 610 (e.g., a face of a first man) swapped into source image 600 at first region 605. Second synthetic image 630 is then generated by adapting an object from second concept input 625 (e.g., a face of a second man that is different from the first man) to first synthetic image 615 at second region 620. That is, second synthetic image 630 depicts two objects swapped into source image 600 by repeated single-object swaps.

Source image 600 is an example of, or includes aspects of, the corresponding element described with reference to FIGS. 3, 4, 7-10, 13, 14, 22, and 23. First region 605 is an example of, or includes aspects of, the corresponding element described with reference to FIG. 5. First concept input 610 is an example of, or includes aspects of, the corresponding element described with reference to FIG. 5. First synthetic image 615 is an example of, or includes aspects of, the corresponding element described with reference to FIG. 5. Second region 620 is an example of, or includes aspects of, the corresponding element described with reference to FIG. 5. Second concept input 625 is an example of, or includes aspects of, the corresponding element described with reference to FIG. 5. Second synthetic image 630 is an example of, or includes aspects of, the corresponding element described with reference to FIG. 5.

FIG. 7 shows an example of cross-domain object swapping according to aspects of the present disclosure. The example shown includes concept input 700, source image 705, target region 710, and synthetic image 715. As illustrated in FIG. 7, concept input 700 is adapted to source image 705 at target region 710 while preserving the style of the source image 705. Cross-domain object swapping is performed using an image generation model (as described with reference to FIGS. 12-14) which maintains the style of source image 705.

In one example, concept input 700 includes a “dog” concept. The dog concept is swapped into a target region 710 of source image 705 which depicts a man wearing a shirt. Target region 710 is located at the center of the man's shirt. The target region 710 of source image 705, before concept swapping, depicts a stylized animal head. Synthetic image 715 adapts the dog concept of concept input 700 in a substantially similar style of the stylized animal head on the man's shirt in source image 705. The concept input 700 is cross-domain swapped to preserve the style and context of source image 705.

Concept input 700 is an example of, or includes aspects of, the corresponding element described with reference to FIGS. 3, 4, 8, 10, 13, 14, 22, and 23. Source image 705 is an example of, or includes aspects of, the corresponding element described with reference to FIGS. 3, 4, 6, 8-10, 13, 14, 22, and 23. Target region 710 is an example of, or includes aspects of, the corresponding element described with reference to FIGS. 3 and 9. Synthetic image 715 is an example of, or includes aspects of, the corresponding element described with reference to FIGS. 3, 4, 8-10, 13, 14, 16, 22, and 23.

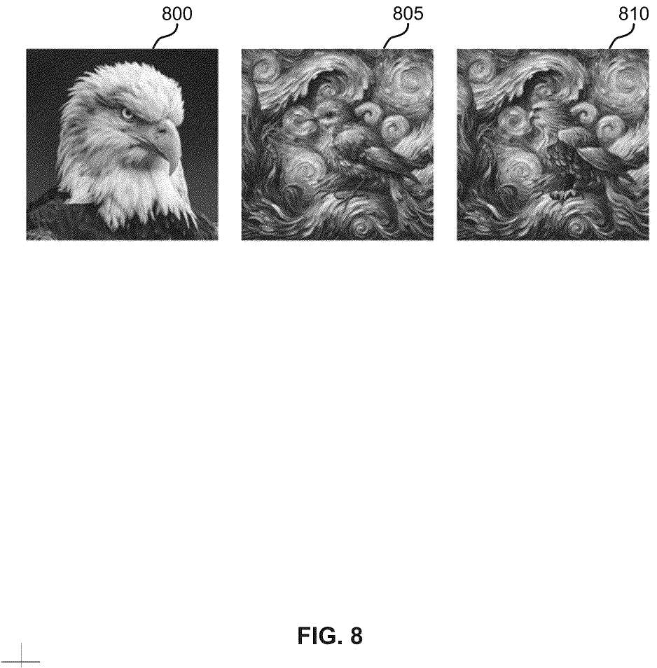

FIG. 8 shows an example of cross-domain object swapping according to aspects of the present disclosure. The example shown includes concept input 800, source image 805, and synthetic image 810. As illustrated by FIG. 8, concept input 800 is adapted to a stylized source image 805 and an image generation model (as described with reference to FIGS. 12-14) generates synthetic image 810 based on the concept input 800 and source image 805. The concept input 800 is adapted to look substantially similar to the style of source image 805. For example, concept input 800 depicts a realistic depiction of an eagle which is swapped into a hyper-stylized depiction of a non-eagle bird (source image 805). In synthetic image 810, the eagle concept is harmoniously adapted to source image 805 while preserving its style (e.g., by replacing or modifying the original “bird” object located in the center). The bird object in synthetic image 810 looks substantially similar to the eagle concept from concept input 800.

Concept input 800 is an example of, or includes aspects of, the corresponding element described with reference to FIGS. 3, 4, 7, 10, 13, 14, 22, and 23. Source image 805 is an example of, or includes aspects of, the corresponding element described with reference to FIGS. 3, 4, 6, 7, 9, 10, 13, 14, 22, and 23. Synthetic image 810 is an example of, or includes aspects of, the corresponding element described with reference to FIGS. 3, 4, 7, 9, 10, 13, 14, 16, 22, and 23.

FIG. 9 shows an example of text-based swapping according to aspects of the present disclosure. The example shown includes source image 900, target region 905, synthetic image 910, and text prompt 915. As illustrated by FIG. 9, synthetic image 910 depicts an object swapped into source image 900 at target region 905, where the object is described in text prompt 915. In one example, source image 900 depicts a woman figure (Mona Lisa from a portrait painting) standing in front of natural landscape and the target region 905 is located on the woman's face. The text prompt 915 provides information for a target object to be swapped into the target region 905 (e.g. “lion”, “tiger”, “cat”). Synthetic image 910 depicts a target object or element from text prompt 915 swapped into the source image 900 to replace the woman's face with the face of a lion, tiger, or cat. For example, synthetic image 910 is generated using an image generation model (as described with reference to FIGS. 12-14) based on source image 900 and text prompt 915 “Lion”.

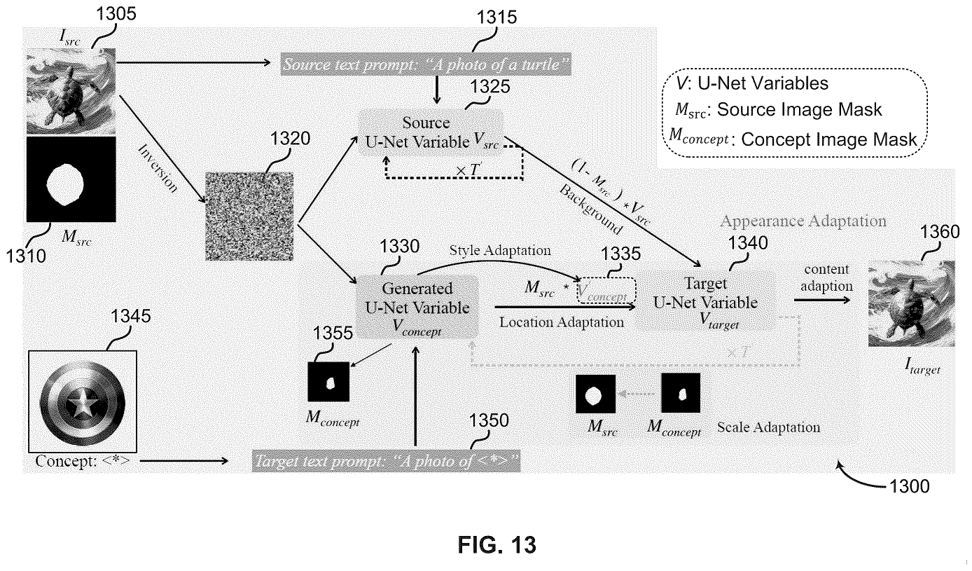

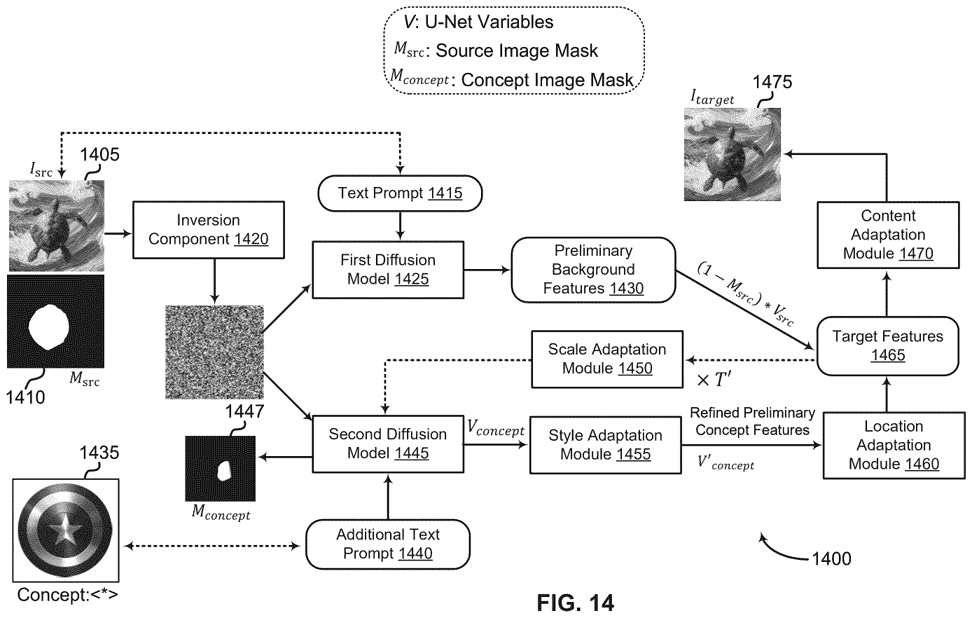

Source image 900 is an example of, or includes aspects of, the corresponding element described with reference to FIGS. 3, 4, 6-8, 10, 13, 14, 22, and 23. Target region 905 is an example of, or includes aspects of, the corresponding element described with reference to FIGS. 3 and 7. Synthetic image 910 is an example of, or includes aspects of, the corresponding element described with reference to FIGS. 3, 4, 7, 8, 10, 13, 14, 16, 22, and 23. Text prompt 915 is an example of, or includes aspects of, the corresponding element described with reference to FIGS. 13 and 14.

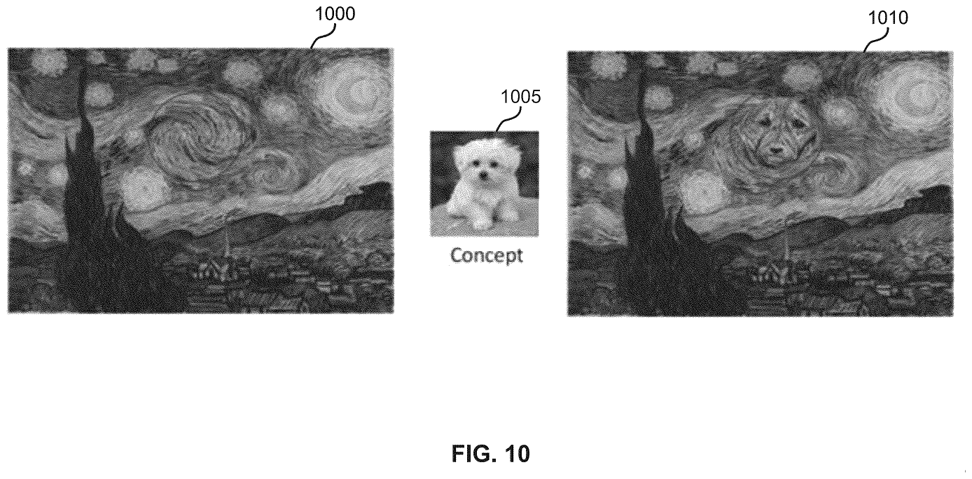

FIG. 10 shows an example of object insertion according to aspects of the present disclosure. The example shown includes source image 1000, concept input 1005, and synthetic image 1010. As illustrated in FIG. 10, concept input 1005 is adapted into source image 1000 to generate synthetic image 1010. In one example, source image 1000 depicts a stylized scene of the sky, and concept input 1005 includes a “dog” object. An image generation model (as described with reference to FIGS. 12-14) generates synthetic image 1010 based on source image 1000 and concept input 1005. Synthetic image 1010 depicts the scene from source image 1000 with the dog from concept input 1005 adapted into the sky (located in the middle of the scene).

Source image 1000 is an example of, or includes aspects of, the corresponding element described with reference to FIGS. 3, 4, 6-9, 13, 14, 22, and 23. Concept input 1005 is an example of, or includes aspects of, the corresponding element described with reference to FIGS. 3, 4, 7, 8, 13, 14, 22, and 23. Synthetic image 1010 is an example of, or includes aspects of, the corresponding element described with reference to FIGS. 3, 4, 7-9, 13, 14, 16, 22, and 23.

FIG. 11 shows an example of a method 1100 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1105, the system obtains a concept input, a source image, and an input mask, where the concept input represents a concept, the source image depicts a scene, and the input mask indicates a location for the concept in the scene. In some examples, the concept input refers to a concept image containing concept information (e.g., a target object). In some cases, the operations of this step refer to, or may be performed by, an image generation model as described with reference to FIGS. 12-14.

In some examples, an input mask is denoted as M_{src}, which is a 2-dimension variable containing 0 and 1. The input mask has the same size as of the source image and value 1 marks the swapping location. The non-masked area is the swapping target area (i.e., performing local swapping), and in some cases the variable(s) is generated via a text prompt to inject the concept's appearance.

At operation 1110, the system generates concept features by performing a style transfer from the source image to the concept input based on the input mask. In some cases, the operations of this step refer to, or may be performed by, a style adaptation module as described with reference to FIGS. 12 and 14. In some cases, the concept features are denoted as

$${V}_{target}^{fg} .$$

The concept features are generated based on the concept input, the source image, and the input mask.

In an embodiment, a process of generating the concept features comprises operations of generating preliminary concept features (denoted as V_{concept}) based on the concept input; generating preliminary background features (denoted as V_{src}) based on the source image; performing the style transfer based on the preliminary concept features, the preliminary background features, and the input mask to obtain refined preliminary concept features (denoted as

$${V}_{c oncept}^{′} ) .$$

The concept features

$${V}_{target}^{fg}$$

are then generated based on the refined preliminary concept features and the input mask. For example, the concept features are computed in Equation

$${V}_{target}^{fg} = {V}_{concept}^{′} * {M}_{s r c} . Here {M}_{s r c}$$

refers to the input mask.

In some examples, AdaIN (adaptive instance normalization) is used to modulate the swapping features with spatial constraints. The style adaptation module denormalizes the V_{concept} with the mean and variance from V_{src} in each time step for V_{target} during the image generation process. As a result, through modulating the preliminary concept features V_{concept}, the generated content adaptively follows the original style in the source image.

At operation 1115, the system generates, using an image generation model, a synthetic image based on the concept features, where the synthetic image depicts the concept from the concept input within the scene from the source image at the location indicated by the input mask. In some cases, the operations of this step refer to, or may be performed by, an image generation model as described with reference to FIGS. 12-14.

In FIGS. 1-11, a method, apparatus, non-transitory computer readable medium, and system for image generation are described. One or more embodiments of the method, apparatus, non-transitory computer readable medium, and system include obtaining a concept input, a source image, and an input mask, wherein the concept input represents a concept, the source image depicts a scene, and the input mask indicates a location for the concept in the scene; generating concept features by performing a style transfer from the source image to the concept input based on the input mask; and generating, using an image generation model, a synthetic image based on the concept features, wherein the synthetic image depicts the concept from the concept input within the scene from the source image at the location indicated by the input mask.

Some examples of the method, apparatus, non-transitory computer readable medium, and system further include obtaining a text prompt describing an element of the source image. Some examples further include generating the input mask based on the source image and the text prompt, wherein the input mask is based on a region of the element described by the text prompt.

Some examples of the method, apparatus, non-transitory computer readable medium, and system further include generating preliminary background features based on the source image. Some examples further include generating background features based on the preliminary background features and the input mask, wherein the synthetic image is generated based on the background features.

Some examples of the method, apparatus, non-transitory computer readable medium, and system further include combining the concept features and the background features to obtain target features, wherein the synthetic image is generated based on the target features.

Some examples of the method, apparatus, non-transitory computer readable medium, and system further include generating preliminary concept features based on the concept input. Some examples further include generating preliminary background features based on the source image. Some examples further include performing the style transfer based on the preliminary concept features, the preliminary background features, and the input mask to obtain refined preliminary concept features. Some examples further include generating the concept features based on the refined preliminary concept features and the input mask. In some examples, the style transfer includes a masked adaptive instance normalization.

Some examples of the method, apparatus, non-transitory computer readable medium, and system further include identifying a shape of the concept using a cross-attention layer of the image generation model. Some examples further include computing shape guidance based on the shape and the input mask, wherein the synthetic image is generated based on the shape guidance.

Some examples of the method, apparatus, non-transitory computer readable medium, and system further include performing boundary smoothing on the input mask to obtain a modified mask, wherein the concept features are generated based on the modified mask.

Some examples of the method, apparatus, non-transitory computer readable medium, and system further include obtaining a noise map. Some examples further include denoising the noise map based on the concept features.

### Network Architecture

FIG. 12 shows an example of an image generation apparatus 1200 according to aspects of the present disclosure. The example shown includes image generation apparatus 1200, processor unit 1205, I/O module 1210, user interface 1215, memory unit 1220, image generation model 1225, and training component 1265. Image generation apparatus 1200 is an example of, or includes aspects of, the corresponding element described with reference to FIG. 1.

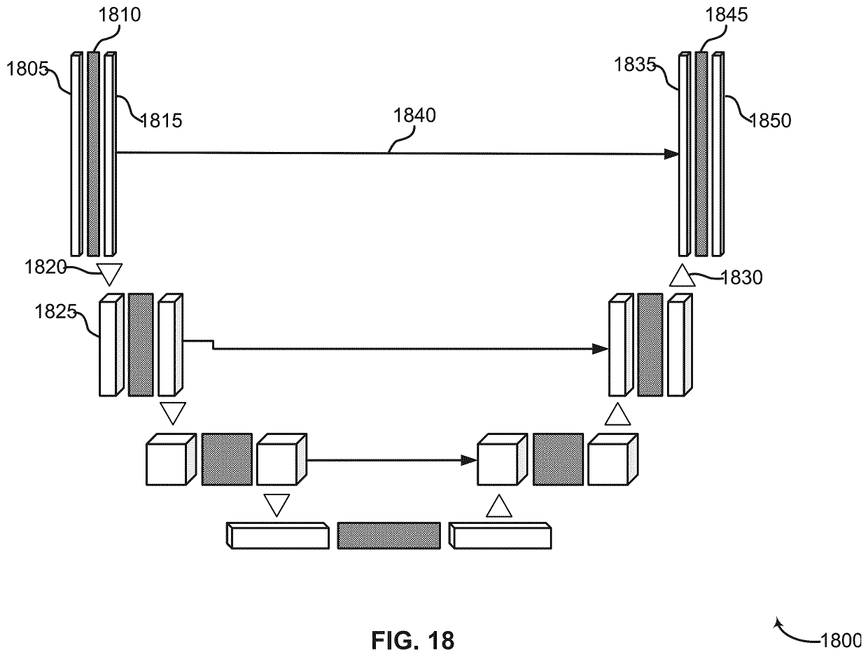

Image generation apparatus 1200 may include an example of, or aspects of, the guided diffusion model described with reference to FIG. 17 and the U-Net described with reference to FIG. 18. In some embodiments, image generation apparatus 1200 includes processor unit 1205, I/O module 1210, user interface 1215, memory unit 1220, image generation model 1225, and training component 1265. Training component 1265 updates parameters of the image generation model 1225 stored in memory unit 1220. In some examples, the training component 1265 is located outside the image generation apparatus 1200.

Processor unit 1205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1205 is configured to operate a memory array using a memory controller. In other cases, a memory controller is integrated into processor unit 1205. In some cases, processor unit 1205 is configured to execute computer-readable instructions stored in memory unit 1220 to perform various functions. In some aspects, processor unit 1205 includes special-purpose components for modem processing, baseband processing, digital signal processing, or transmission processing. According to some aspects, processor unit 1205 comprises one or more processors described with reference to FIG. 26.

Memory unit 1220 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1205 to perform various functions described herein.

In some cases, memory unit 1220 includes a basic input/output system (BIOS) that controls basic hardware or software operations, such as an interaction with peripheral components or devices. In some cases, memory unit 1220 includes a memory controller that operates memory cells of memory unit 1220. For example, the memory controller may include a row decoder, column decoder, or both. In some cases, memory cells within memory unit 920 store information in the form of a logical state. According to some aspects, memory unit 920 is an example of the memory subsystem 2610 described with reference to FIG. 26.

According to some aspects, image generation apparatus 1200 uses one or more processors of processor unit 1205 to execute instructions stored in memory unit 1220 to perform functions described herein. For example, image generation apparatus 1200 may obtain a concept input, a source image, and an input mask, wherein the concept input represents a concept, the source image depicts a scene, and the input mask indicates a location for the concept in the scene. Image generation apparatus 1200 generates concept features by performing a style transfer from the source image to the concept input based on the input mask. Image generation apparatus 1200 generates, using image generation model 1225, a synthetic image based on the concept features, wherein the synthetic image depicts the concept from the concept input within the scene from the source image at the location indicated by the input mask.

The memory unit 1220 may include an image generation model 1225 trained to obtain a concept input, a source image, and an input mask, wherein the concept input represents a concept, the source image depicts a scene, and the input mask indicates a location for the concept in the scene; generate concept features by performing a style transfer from the source image to the concept input based on the input mask; and generate a synthetic image based on the concept features, wherein the synthetic image depicts the concept from the concept input within the scene from the source image at the location indicated by the input mask. For example, after training, the image generation model 1225 may perform inferencing operations as described with reference to FIGS. 2, 11 and 20-21.

In some embodiments, the image generation model 1225 is an artificial neural network (ANN) such as the guided diffusion model described with reference to FIG. 17 and the U-Net described with reference to FIG. 18. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 1225 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1265 may train the image generation model 1225. For example, parameters of the image generation model 1225 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 24-25). The goal of the training process may be to find optimal values for the parameters that allow the machine learning model to make accurate predictions or perform well on the given task.

Accordingly, the node weights can be adjusted to increase the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 1225 can be used to make predictions on new, unseen data (i.e., during inference).

I/O module 1210 receives inputs from and transmits outputs of the image generation apparatus 1200 to other devices or users. For example, I/O module 1210 receives inputs for the image generation model 1225 and transmits outputs of the image generation model 925. According to some aspects, I/O module 1210 is an example of the I/O interface 2620 described with reference to FIG. 26.

Image generation model 1225 is an example of, or includes aspects of, the corresponding element described with reference to FIGS. 13 and 14. In one embodiment, image generation model 1225 includes diffusion model 1230, segmentation model 1235, inversion component 1240, location adaptation module 1245, style adaptation module 1250, scale adaptation module 1255, and content adaptation module 1260.

According to some embodiments, image generation model 1225 obtains a concept input, a source image, and an input mask, where the concept input represents a concept, the source image depicts a scene, and the input mask indicates a location for the concept in the scene. In some examples, image generation model 1225 generates a synthetic image based on the concept features, where the synthetic image depicts the concept from the concept input within the scene from the source image at the location indicated by the input mask.

According to some embodiments, image generation model 1225 generates concept features by performing a style transfer from the source image to the concept input based on the input mask. In some examples, the image generation model 1225 includes a diffusion U-Net. In some examples, the image generation model 1225 includes a location adaptation module 1245, a style adaptation module 1250 including an instance normalization component, a scale adaptation module 1255, and a content adaptation module 1260.

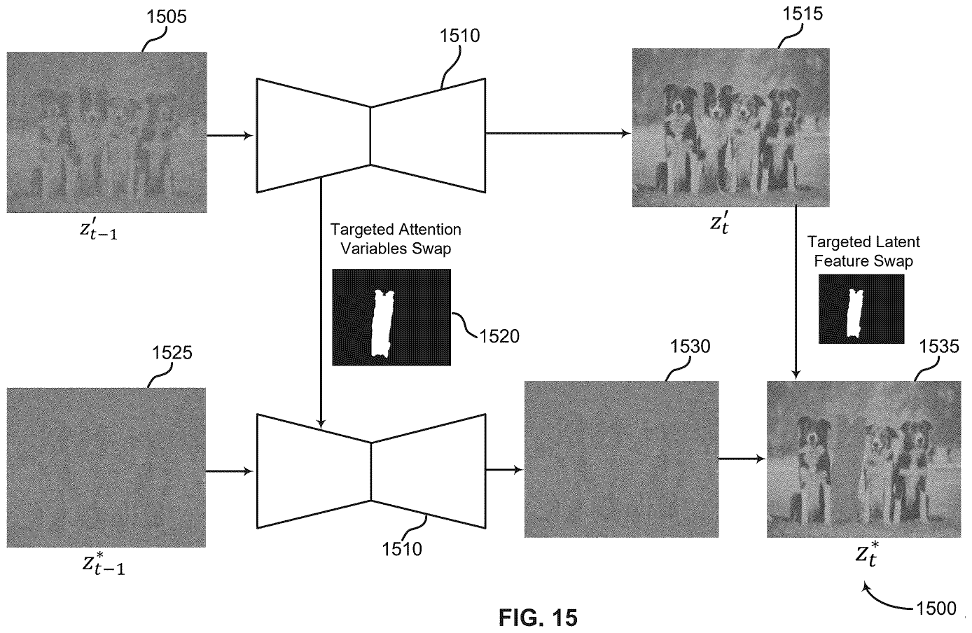

According to some embodiments, diffusion model 1230 obtains a noise map. In some examples, diffusion model 1230 denoises the noise map based on the concept features. Diffusion model 1230 is an example of, or includes aspects of, the corresponding element described with reference to FIG. 15.

Diffusion model 1230 belongs to the family of generative models that are based on stochastic processes. Diffusion model 1230 generates an image by iteratively reducing noise from an initial distribution. Starting from a point of random noise denoted as Zr, which follows a normal distribution z_{T}˜ [symbol] (0, 1), diffusion model 1230 denoises each instance zₜ, thus producing zₜ₋₁. Diffusion model 1230 predicts and reverses the noise at each step in the diffusion sequence to arrive at the final denoised image.

In some examples, image generation model 1225 includes a pre-trained text-to-image diffusion model (e.g., Stable Diffusion). Diffusion model 1230 encodes images into a latent space and incrementally denoises the encoded latent representation. Diffusion model 1230 operates on a U-Net architecture, where the latent representation zₜ₋₁ at any given step is derived from the text prompt P and the previous latent state zₜ, as indicated by the following equation:

$${z}_{t - 1} = ϵθ ( {z}_{t} , P , t ) \qquad ( 1 )$$

The U-Net includes sequence of layers that repeatedly apply self-attention and cross-attention mechanisms. In self-attention, the latent image feature zₜ, is first projected into query Q_{self}, K_{self}, V_{self}, which are then used to compute self-attention map A and self-attention output φ.

$$M = softmax ( \frac{{Q}_{self} \cdot {K}_{self}^{T}}{\sqrt{d}} ) ϕ = M \cdot {V}_{self} \qquad ( 2 )$$

For cross-attention layer, the feature out of previous self-attention layer is projected into Q_{cross}, while feature embedding of textual prompt is projected into K_{cross} and V_{cross}.

$$A = softmax ( \frac{{Q}_{c r o s s} \cdot {K}_{c r o s s}^{T}}{\sqrt{d}} ) \qquad ( 3 )$$

where A is the cross-attention map. In some examples, image generation model 1225 performs swapping of A, M, φ and z.

According to some embodiments, segmentation model 1235 obtains a text prompt describing an element of the source image. In some examples, segmentation model 1235 generates the input mask based on the source image and the text prompt, where the input mask is based on a region of the element described by the text prompt.

According to some embodiments, inversion component 1240 generates preliminary background features based on the source image. Inversion component 1240 is an example of, or includes aspects of, the corresponding element described with reference to FIG. 14.

According to some aspects, location adaptation module 1245 generates background features based on the preliminary background features and the input mask, where the synthetic image is generated based on the background features. Location adaptation module 1245 is an example of, or includes aspects of, the corresponding element described with reference to FIG. 14.

According to some embodiments, style adaptation module 1250 generates concept features by performing a style transfer from the source image to the concept input based on the input mask. In some examples, style adaptation module 1250 combines the concept features and the background features to obtain target features, where the synthetic image is generated based on the target features.

In some examples, style adaptation module 1250 generates preliminary concept features based on the concept input. Style adaptation module 1250 generates preliminary background features based on the source image. Style adaptation module 1250 performs the style transfer based on the preliminary concept features, the preliminary background features, and the input mask to obtain refined preliminary concept features. Style adaptation module 1250 generates the concept features based on the refined preliminary concept features and the input mask. Style adaptation module 1250 is an example of, or includes aspects of, the corresponding element described with reference to FIG. 14.

In an embodiment, scale adaptation module 1255 identifies a shape of the concept using a cross-attention layer of the image generation model 1225. Scale adaptation module 1255 computes shape guidance based on the shape and the input mask, where the synthetic image is generated based on the shape guidance. Scale adaptation module 1255 is an example of, or includes aspects of, the corresponding element described with reference to FIG. 14.

According to some embodiments, content adaptation module 1260 performs boundary smoothing on the input mask to obtain a modified mask, where the concept features are generated based on the modified mask. Content adaptation module 1260 is an example of, or includes aspects of, the corresponding element described with reference to FIG. 14.

In some embodiments, image generation model 1225 includes Stable Diffusion as a pre-trained text-to-image diffusion model. The inversion component 1240 converts the concept into a textual space. In some examples, null-text inversion is used based on DDIM inversion to boost accuracy and reliability of the inversion.

For object mask, image generation model 1225 detects the object with an encoder such as DINO and then extracts the mask using a segmentation model. For the targeting variable swapping process, in some examples, do 30 steps for latent image feature z, 20 steps for cross-attention map, 25 steps for the self-attention map, and 10 steps for the self-attention output. The image generation model 1225 conducts swapping in all U-Net layers. There is no additional operation for single-object, partial object, cross domain swapping. Multi-object swapping is achieved by conducting swapping operation on the previous swapped image.

In some examples, experiments are conducted on both human and non-human objects. For human swapping, training component 1265 may collect celebrities (e.g., celebrity images) from internet searches. A search prompt is “a photo of <target>”, where <target> is the celebrity name. The training component 1265 collects images of 15 celebrities for the concept learning process. The training component 1265 collects 500 images containing one or more people as the source images. For non-human object, training component 1265 includes DreamEdit dataset and more concepts and its corresponding source images from Google® search. In some examples, training component 1265 aggregated 1,000 images.

Baseline models involve attention variable based image editing methods, which are compatible with the described masked latent blending and location adaptation with reference to FIGS. 13-16. In some examples, an external mask is used to help the inpainting process.

FIG. 13 shows an example of an image generation model 1300 according to aspects of the present disclosure. The example shown includes image generation model 1300, source image 1305, input mask 1310, text prompt 1315, noise map 1320, preliminary background features 1325, preliminary concept features 1330, refined preliminary concept features 1335, target features 1340, concept input 1345, additional text prompt 1350, concept mask 1355, and synthetic image 1360. Image generation model 1300 is an example of, or includes aspects of, the corresponding element described with reference to FIGS. 12 and 14.

Image generation model 1300 includes a diffusion model that swaps a concept/object to a target area faithfully while preserving the context pixels. FIGS. 13 and 14 illustrate an overall structure of image generation model 1300. For source image I_{src}, image generation model 1300 inverts source image 1305 to obtain a latent noise (i.e., noise map 1320) and then generates the feature representations V_{src}, which is then used during the target image generation process (generating I_{target}). FIGS. 13 and 14 describe a method for preserving the non-target pixels in the source image, and a method for selecting and transferring key information about the source image. Additionally, image generation model 1300 includes an appearance adaptation network (e.g., location adaptation, style adaptation, scale adaptation, content adaptation) that uses the key information to integrate the new concept into the source image 1305 seamlessly. In some cases, source image 1305 is denoted as I_{src}. Preliminary background features 1325 is denoted as V_{src}. Preliminary concept features 1330 is denoted as V_{concept}. Refined preliminary concept features 1335 is denoted as V′_{concept}. Target features 1340 is denoted as V_{target}. Synthetic image 1360 is denoted as I_{target}. Input mask 1310 is denoted as M_{src}.

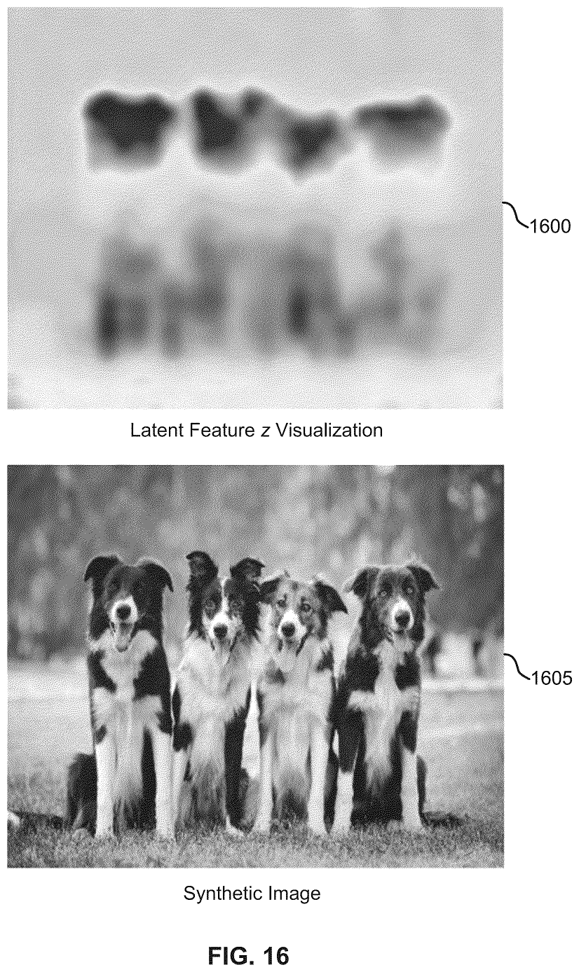

Intermediate variables in U-Net of a diffusion model are informative about the content of the generated image. Conventional methods focus on variables inside of a U-Net structure, such as an attention map and attention output, while one or more embodiments of the present disclosure also explore the output of U-Net at each diffusion step, i.e., latent image feature z because the latent image feature z contains more information on image content control. The image generation process for the latent diffusion model is achieved by denoising the z to arrive at a clear representation of a high-quality image, whereas all other variables inside of U-Net indirectly affect the image by impacting z. In contrast to simply swapping z like other variables, which would erase the new image's details and result in a mere duplication of the original image, image generation model 1300 uses significant correlation between the latent feature z and the generated image, including a pixel-level correspondence. As shown in FIG. 16, the main component of the averaged latent feature z is visualized across all diffusion steps. It has a part-to-part correspondence with the generated images indicates the potential of localized editing by manipulating the latent feature.

Consequently, image generation model 1300 incorporates a method of altering exclusively the context pixels within z, affecting solely the intended pixel. Embodiments of the present disclosure constrain the exchange of the latent feature to the initial stages of diffusion, allowing subsequent steps to smooth out any discordance in the latent space. Furthermore, exploration into U-Net's cross-attention map M, self-attention map A, and self-attention output ¿ reveals their ability to mitigate artifacts. Swapping those can facilitate the alignment of the latent features between the source image 1305 and target image before the partial swapping between them. In some examples, the variables mentioned above in the source image 1305 and target image generation process (e.g., synthetic image 1360) may be resized into the shape of the input mask 1310, where the input mask 1310 is utilized for the swapping process.

$${V}_{target} = g ( f ( {V}_{s r c} ) * ( 1 - {M}_{s r c} ) + f ( {V}_{target} ) * {M}_{s r c} ) \qquad ( 4 )$$

Here V includes latent feature z, and other assistant variable cross-attention map M, self-attention map A, and self-attention output φ. f(⋅) means the transformation process to the shape of the input mask 1310, while g(⋅) means the transformation back to the original space. For simplicity, f(⋅) and g(⋅) are ignored in the following description. The content in the latent feature of the source image 1305 is changing as the diffusion process continues. Therefore, the location of the correspondent pixel in latent space may change over diffusion steps.

One solution is to decode the latent feature z into an image at each step and extract the mask dynamically according to the object location in the generated image. However, a changing mask may confuse the model and lead to a less optimal performance. Therefore, while using the same high-quality input mask 1310 through the diffusion process, the input mask 1310 is either extracted from the source image directly using an off-the-shelf model or from the generation process.

In some embodiments, the image generation model 1300 incorporates an appearance adaptation process that adapts the concept (i.e., concept input 1345) into the source image 1305, which incorporates meticulous adjustments across several dimensions such as location, style, scale, and content. The image generation model 1300 increases realism and coherence in image manipulation.

Various intermediate variables correlate with the final generated image (i.e., synthetic image 1360). In some examples, the background is modified. For each step, instead of directly swapping the whole variable(s), image generation model 1300 performs local swapping to exclusively swap the non-object position. Also, to enhance the swapping results, the image generation model 1300 performs local swapping on the latent representation z directly. M_{src} is a 2-dimension variable containing 0 and 1. It is the same size as source image 1305 and value 1 marks the swapping location. To simplify the expression, U-Net variables attention map, attention output, and latent representation for the original image recovery process are denoted as V_{src}. The variables generated via target text prompt are denoted as V_{concept}. The target variable

$${V}_{target}^{b g}$$

refers to background information of the target variable, which is obtained via Eq. (5) as follows:

$${V}_{target}^{b g} = {V}_{s r c} * ( 1 - {M}_{s r c} ) \qquad ( 5 )$$

The non-masked area is the swapping target area, where the variable is to be generated via the target text prompt (i.e., an additional text prompt 1350) to adapt and incorporate the concept's appearance. Location adaptation extends beyond object swapping tasks. For example, location adaptation can be applied in object insertion tasks.

In an embodiment, image generation model 1300 includes a pre-trained text-to-image diffusion model (e.g., Stable Diffusion). A text encoder is used to convert the concept input 1345 into textual space. The learning rate for this process is set at 1e-6, and Adam optimizer is used for 800 steps. The U-Net and the text encoder are fine-tuned during this process. The target prompt is essentially the source prompt with a swap in object tokens to introduce a new concept.

For area mask smoothing, image generation model 1300 enlarges the masked area(s) using a dilation operation with an elliptical kernel, which can be adjusted in size. After dilation, the mask edges are smoothed using a Gaussian blur, creating a gradient effect on the boundaries. For the smooth over diffusion step, some examples linearly increase the mask rate from 0 to 1 during the first 30 steps. A masked area is represented using a circle in the Figures.

FIG. 13 illustrates an example of swapping an object from source image 1305 (I_{src}) into a personalized concept (<*>) to obtain the target image (I_{target} or synthetic image 1360). In some embodiments, the personalized concept is converted into textual space to be treated as concept appearance. The source image 1305 is inverted into initial noise to obtain U-Net variables (including latent feature, attention map, and attention output). Targeted variable swapping preserves the context pixels in the source image 1305. The appearance adaptation process then utilizes these informative variables to integrate the concept into the target image.

Source image 1305 is an example of, or includes aspects of, the corresponding element described with reference to FIGS. 3, 4, 6-10, 14, 22, and 23. Input mask 1310 is an example of, or includes aspects of, the corresponding element described with reference to FIGS. 14, 15, and 22. Text prompt 1315 is an example of, or includes aspects of, the corresponding element described with reference to FIGS. 9 and 14. Noise map 1320 is an example of, or includes aspects of, the corresponding element described with reference to FIG. 15. Preliminary background features 1325 is an example of, or includes aspects of, the corresponding element described with reference to FIG. 14. Target features 1340 is an example of, or includes aspects of, the corresponding element described with reference to FIG. 14. Concept input 1345 is an example of, or includes aspects of, the corresponding element described with reference to FIGS. 3, 4, 7, 8, 10, 14, 22, and 23. Additional text prompt 1350 is an example of, or includes aspects of, the corresponding element described with reference to FIG. 14. Synthetic image 1360 is an example of, or includes aspects of, the corresponding element described with reference to FIGS. 3, 4, 7-10, 14, 16, 22, and 23.

FIG. 14 shows an example of an image generation model 1400 according to aspects of the present disclosure. The example shown includes image generation model 1400, source image 1405, input mask 1410, text prompt 1415, inversion component 1420, first diffusion model 1425, preliminary background features 1430, concept input 1435, additional text prompt 1440, second diffusion model 1445, scale adaptation module 1450, style adaptation module 1455, location adaptation module 1460, target features 1465, content adaptation module 1470, and synthetic image 1475. Image generation model 1400 is an example of, or includes aspects of, the corresponding element described with reference to FIGS. 12 and 13.

In some embodiments, the image generation model 1400 performs object swapping while keeping the style unchanged. The object information in the generated variables is injected via the new concept token. Some style attributes are already bound with the token. Therefore, solely generating the foreground information via a text prompt 1415 may lead to style inconsistency. Adding normalization layers can improve the conditional image generation quality because such an activation works as modulation. Unlike conventional methods, the image generation model 1400 includes AdaIN (adaptive instance normalization) to modulate the swapping features with spatial constraints. The image generation model 1400 denormalizes the V_{concept} with the mean and variance from V_{src} in each time step for V_{target} during the image generation process as formulated in Eq. (6) and Eq. (7). V_{src} is also referred to as preliminary background features 1430. V_{concept} is also referred to as preliminary concept features.

As a result, by modulating the concept feature, the generated content can adaptively follow the original style in the source image 1405.

$${V}_{concept}^{′} = MaskedAdalN ( {V}_{s c r} , {V}_{c o n cept} , {M}_{s r c} ) \qquad ( 6 )$$

$${V}_{target}^{f g} = {V}_{concept}^{′} * {M}_{s r c} \qquad ( 7 )$$

In Eq. (7), V′_{concept} is also referred to as refined preliminary concept features.

$${V}_{target}^{f g}$$

is referred to as concept features. In some examples, MaskedAdaIN utilizes the mean and variance from the masked region in the AdaIN calculation. The image generation model 1400 computes the blended feature representations for V_{target}:

$${V}_{target} = {V}_{target}^{f g} + {V}_{target}^{b g} \qquad ( 8 )$$

In some cases,

$${V}_{target}^{f g}$$

is referred to as concept features and

$${V}_{target}^{b g}$$

is referred to as background features.

The proportion of an object compared to its environment and other elements in the image is relevant information for achieving image coherence. A swapping result with improper scaling can disturb the aesthetic balance, resulting in a disjoint appearance of the image. Guidance from an external classifier in the inference process of diffusion models influences the diffusion noise to control the generated image. The guidance can also be used on the attention map to control the generation. In an embodiment, the image generation model 1400 adapts the mask guidance (as formulated in Eq. (9)), using scale adaptation module 1450, to better align the shape between the source object and the target object.

$${\hat{ϵ}}_{t} = ( 1 + s ) + {ϵ}_{θ} ( {z}_{t} ; t , y ) - s {ϵ}_{θ} ( {z}_{t} ; t , ∅ ) + v {σ}_{t} {∇}_{{z}_{t}} {‖ {M}_{s r c} - Shape ( {M}_{s r c} ) ( k ) ‖}_{1} \qquad ( 9 )$$

where s is the classifier-free guidance strength and v is an additional guidance weight for g.

As with classifier guidance, the scale adaptation module 1450 scales by σₜ to convert the score function to a prediction of εₜ. Shape(M_{src})(k) denotes the object shape as identified in the cross-attention layer. Here the energy function g is formulated as ∥M_{src}−Shape(M_{src})(k) ∥₁ to calculate the shape difference between the original object mask and the extracted shape of object token k in the attention layer, which indicates the deviation between the intended shape and shape during the diffusion process.

A binary mask without smoothing has a high-frequency transition at the edge, e.g., it jumps abruptly from 0 to 1. When used to merge two intermediate variables from two different diffusion processes, this can result in high-frequency artifacts at the boundary, such as jagged edges or a halo effect. Smoothing the mask transitions these high frequencies into lower frequencies, which blends the images more naturally and eliminates such artifacts. A smooth mask creates a feathering effect at the edges of the transition. This makes the merged area appear more coherent as if the two images naturally blend into each other rather than being cut off abruptly. Therefore, for the diffusion process, the image generation model 1400 implements two masks, via content adaptation module 1470, according to the feature of diffusion models.

Without this smoothing, the boundary between the images is sharply defined, leading to a jarring and unnatural appearance. The Gaussian Blur softens the edges, blending the images more seamlessly. To augment this improved blending, the image generation model 1400 applies two smoothing techniques for binary masks, applied across both spatial dimensions and temporal steps. These techniques serve to refine the swapping process, mitigating artifacts and ensuring a smoother, more natural integration of the swapped regions. This results in an enriched visual output, seamlessly blending the inserted objects or object parts into the overall image composition.

In an embodiment, the content adaptation module 1470 applies linear boundary interpolation, which is a process where the sharp transition between the area with 1s and the area with 0s in binary array is made gradual. One way to achieve this is by using a convolution with a smoothing kernel (like a Gaussian kernel) that can average the values in the vicinity of each point, effectively creating a gradient at the boundary.

$$δ ( {M}_{src} 0 = {M}_{src} ⊕ K \qquad ( 10 )$$

$$S = δ ( {M}_{src} ) * G$$

$${S}^{′} [ i , j ] = \{ \begin{matrix}1 & if M [ i , j ] = 1 \\ S [ i , j ] & otherwise\end{matrix}$$

In some examples, the dilation of the mask M_{src} using the structuring element K, where denotes the dilation operation and G is the Gaussian kernel. The asterisk * denotes the convolution operation. S′ is the final soft mask.

In an embodiment, content adaptation module 1470 applies gradual boundary transition, which involves generating a sequence of arrays where the value of 1 does not appear immediately but increases incrementally from 0 to 1. This is obtained by interpolating between 0 and 1 across the sequence of arrays.

$${M}_{src} ( x , y ) = \{ \begin{matrix}{M}_{src} ( x , y ) \cdot \frac{t}{K} , & if t \leq K and {M}_{src} ( x , y ) = 1 \\ {M}_{src} ( x , y ) , & otherwise\end{matrix} \qquad ( 11 )$$

In the above equation, the value of M_{src}(x, y) is assumed to be 1 in the center area and 0 elsewhere. For the central region, the value linearly increases from 0 to 1 over the first K steps. For the rest of the mask, the original value M_{src}(x, y) remains unchanged.

Several backbone diffusion models (e.g., Stable Diffusion) are restricted to processing images in a square format. Resizing images to fit a square dimension can lead to substantial content distortion, adversely affecting the editing outcomes. Nevertheless, the methods and models described in the present disclosure exhibit a remarkable capacity for adaptation, allowing the model to process images of any aspect ratio without compromise. For example, images described in the present disclosure are in various ratios.

In an embodiment, style adaptation module 1455 adjusts the mean and variance of content image features to match those of the style features, facilitating the transfer of artistic styles onto content images. The AdaIN technique enables real-time style transfer and artistic image manipulation. Conventional AdaIN applies style alignment across an entire image. The described Masked-AdaIN focuses this alignment on a specific target area. Accordingly, mean and variance calculations are exclusively performed on the designated masked area, leading to more precise and localized style transfers.

In an embodiment, scale adaptation module 1450 adapts the scale of the object in latent space to the shape of the mask. The object shape is indicated in the cross-attention map at each diffusion step. Shape(M_{src})(k) means the attention map for object text token k, which is obtained through binary-like transformation to the attention map. In some examples, scale adaptation module 1450 applies a threshold of 0.4 after using sigmoid to normalize the attention value between 0 and 1.

In an embodiment, content adaptation module 1470 performs content adaptation. In the linear boundary interpolation process, the structuring element K is a predefined shape used in the dilation process to create the dilated image. The structuring element K slides over the binary mask M_{src} and at each position. If at least one pixel under K is 1, the pixel in the output image under the center of K is set to 1. This operation typically results in the enlargement of the regions with Is in the binary mask, effectively smoothing the boundary and filling small holes and gaps. The subsequent convolution with a Gaussian kernel G further smooths the mask by averaging values in the vicinity of each point, thereby creating a gradient effect. The combination of dilation and Gaussian smoothing prepares the mask S′ for linear boundary interpolation, where the sharp transitions are made gradual, and the final soft mask S′ is obtained by selectively setting pixels to 1 based on the original mask and the smoothed values. In gradual boundary transition, content adaptation module 1470 sets the transition step parameter as 30 to anneal M_{src} from 0 to the set value.

Source image 1405 is an example of, or includes aspects of, the corresponding element described with reference to FIGS. 3, 4, 6-10, 13, 22, and 23. Input mask 1410 is an example of, or includes aspects of, the corresponding element described with reference to FIGS. 13, 15, and 22. Text prompt 1415 is an example of, or includes aspects of, the corresponding element described with reference to FIGS. 9 and 13. Inversion component 1420 is an example of, or includes aspects of, the corresponding element described with reference to FIG. 12. Preliminary background features 1430 is an example of, or includes aspects of, the corresponding element described with reference to FIG. 13. Concept input 1435 is an example of, or includes aspects of, the corresponding element described with reference to FIGS. 3, 4, 7, 8, 10, 13, 22, and 23. Additional text prompt 1440 is an example of, or includes aspects of, the corresponding element described with reference to FIG. 13. Scale adaptation module 1450 is an example of, or includes aspects of, the corresponding element described with reference to FIG. 12. Style adaptation module 1455 is an example of, or includes aspects of, the corresponding element described with reference to FIG. 12. Location adaptation module 1460 is an example of, or includes aspects of, the corresponding element described with reference to FIG. 12. Target features 1465 is an example of, or includes aspects of, the corresponding element described with reference to FIG. 13. Content adaptation module 1470 is an example of, or includes aspects of, the corresponding element described with reference to FIG. 12. Synthetic image 1475 is an example of, or includes aspects of, the corresponding element described with reference to FIGS. 3, 4, 7-10, 13, 16, 22, and 23.

FIG. 15 shows an example of targeted variable manipulation in a diffusion process according to aspects of the present disclosure. The example shown includes swapping process 1500, feature map 1505, diffusion model 1510, denoised feature map 1515, input mask 1520, noise map 1525, denoised map 1530, and target feature map 1535.

Intermediate variables in the U-Net of a diffusion model provide information about the content of the generated image. Instead of focusing on variables inside of U-Net such as attention map and attention output, embodiments of the present disclosure explore output of U-Net at each diffusion step, i.e., latent image feature z. The latent image feature z contains more information on image content control. Image generation using a latent diffusion model involves a process of denoising the z to arrive at a clear representation of a high-quality image, whereas all other variables inside U-Net indirectly affect the image by impacting z. In contrast to simply swapping z like other variables, which would erase the new image's unique details and result in a mere duplication of the original image, the swapping process 1500 shows a significant correlation between the latent feature z and the generated image, including a pixel-level correspondence. FIG. 16 shows a visualization of a main component of the averaged latent feature z across all diffusion steps. The latent feature z visualization has a part-to-part correspondence with the generated images, which proves the potential of localized editing by manipulating the latent feature.

Diffusion model 1510 is an example of, or includes aspects of, the corresponding element described with reference to FIG. 12. Input mask 1520 is an example of, or includes aspects of, the corresponding element described with reference to FIGS. 13, 14, and 22. Noise map 1525 is an example of, or includes aspects of, the corresponding element described with reference to FIG. 13.

FIG. 16 shows an example of correspondence between a latent feature and a synthetic image 1605 according to aspects of the present disclosure. The example shown includes latent feature visualization 1600 and synthetic image 1605. Synthetic image 1605 is an example of, or includes aspects of, the corresponding element described with reference to FIGS. 3, 4, 7-10, 13, 14, 22, and 23.

As illustrated in FIG. 16, latent feature visualization 1600 has a part-to-part correspondence with synthetic image 1605. In some cases, latent feature visualization 1600 is the output of a U-Net at a diffusion step. The U-Net is an example of, or includes aspects of, the corresponding element described with reference to FIG. 18. Synthetic image 1605 is generated by denoising latent features during a reverse diffusion process. Latent feature visualization 1600 is a visualization of one of these latent features. In some cases, latent feature visualization 1600 depicts a latent feature in a pixel space as opposed to a latent space. In some examples, an image generation model (as described in FIGS. 12-14) modifies exclusively the context pixels in a latent feature to affect targeted pixels. The exchange of latent features occurs during the initial stages of diffusion to smooth out discordance in the latent space.

FIG. 17 shows an example of a guided diffusion model according to aspects of the present disclosure. The guided latent diffusion model 1700 depicted in FIG. 17 is an example of, or includes aspects of, the corresponding element (i.e., diffusion model 1230) described with reference to FIG. 12.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 1700 may take an original image 1705 in a pixel space 1710 as input and apply and image encoder 1715 to convert original image 1705 into original image features 1720 in a latent space 1725. Then, a forward diffusion process 1730 gradually adds noise to the original image features 1720 to obtain noisy features 1735 (also in latent space 1725) at various noise levels.

Next, a reverse diffusion process 1740 (e.g., a U-Net ANN) gradually removes the noise from the noisy features 1735 at the various noise levels to obtain denoised image features 1745 in latent space 1725. In some examples, the denoised image features 1745 are compared to the original image features 1720 at each of the various noise levels, and parameters of the reverse diffusion process 1740 of the diffusion model are updated based on the comparison. Finally, an image decoder 1750 decodes the denoised image features 1745 to obtain an output image 1755 in pixel space 1710. In some cases, an output image 1755 is created at each of the various noise levels. The output image 1755 can be compared to the original image 1705 to train the reverse diffusion process 1740.

In some cases, image encoder 1715 and image decoder 1750 are pre-trained prior to training the reverse diffusion process 1740. In some examples, image encoder 1715 and image decoder 1750 are trained jointly, or the image encoder 1715 and image decoder 1750 and fine-tuned jointly with the reverse diffusion process 1740.

The reverse diffusion process 1740 can also be guided based on a text prompt 1760, or another guidance prompt, such as an image, a layout, a segmentation map, etc. The text prompt 1760 can be encoded using a text encoder 1765 (e.g., a multimodal encoder) to obtain guidance features 1770 in guidance space 1775. The guidance features 1770 can be combined with the noisy features 1735 at one or more layers of the reverse diffusion process 1740 to ensure that the output image 1755 includes content described by the text prompt 1760. For example, guidance features 1770 can be combined with the noisy features 1735 using a cross-attention block within the reverse diffusion process 1740.

FIG. 18 shows an example of a U-Net 1800 architecture according to aspects of the present disclosure. In some examples, U-Net 1800 is an example of the component that performs the reverse diffusion process 1740 of guided latent diffusion model 1700 described with reference to FIG. 17 and includes architectural elements of the image generation model 1225 described with reference to FIG. 12. The U-Net 1800 depicted in FIG. 18 is an example of, or includes aspects of, the architecture used within the reverse diffusion process described with reference to FIG. 17.

In some examples, diffusion models are based on a neural network architecture known as a U-Net. The U-Net 1800 takes input features 1805 having an initial resolution and an initial number of channels and processes the input features 1805 using an initial neural network layer 1810 (e.g., a convolutional network layer) to produce intermediate features 1815. The intermediate features 1815 are then down-sampled using a down-sampling layer 1820 such that down-sampled features 1825 have a resolution less than the initial resolution and a number of channels greater than the initial number of channels.

This process is repeated multiple times, and then the process is reversed. That is, the down-sampled features 1825 are up-sampled using up-sampling process 1830 to obtain up-sampled features 1835. The up-sampled features 1835 can be combined with intermediate features 1815 having the same resolution and number of channels via a skip connection 1840. These inputs are processed using a final neural network layer 1845 to produce output features 1850. In some cases, the output features 1850 have the same resolution as the initial resolution and the same number of channels as the initial number of channels.

In some cases, U-Net 1800 takes additional input features to produce conditionally generated output. For example, the additional input features could include a vector representation of an input prompt. The additional input features can be combined with the intermediate features 1815 within the neural network at one or more layers. For example, a cross-attention module can be used to combine the additional input features and the intermediate features 1815.

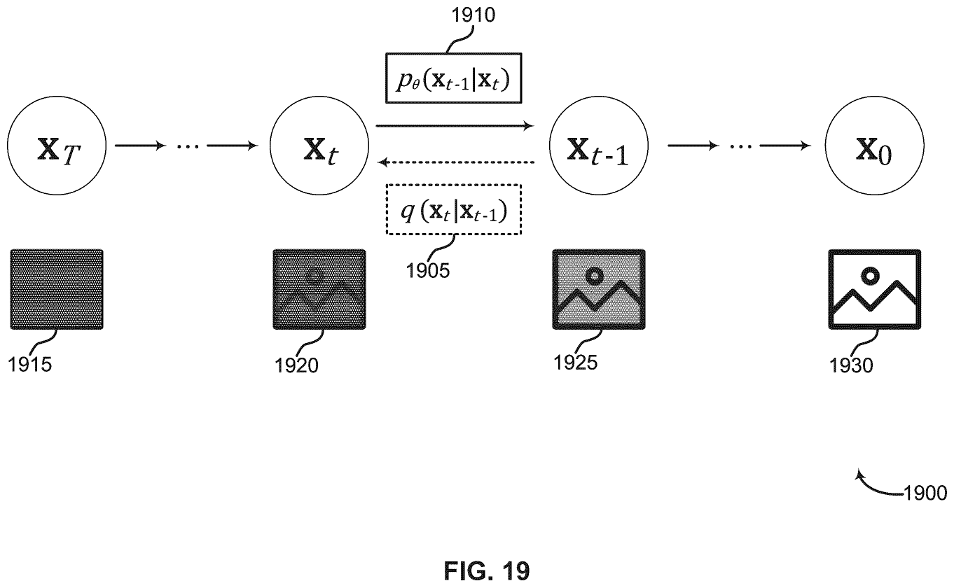

FIG. 19 shows an example of a diffusion process 1900 according to aspects of the present disclosure. In some examples, diffusion process 1900 describes an operation of the image generation model 1225 described with reference to FIG. 12, such as the reverse diffusion process 1740 of guided latent diffusion model 1700 described with reference to FIG. 17.

As described above with reference to FIGS. 17 and 19, using a diffusion model can involve both a forward diffusion process 1905 for adding noise to a media item (or features in a latent space) and a reverse diffusion process 1910 for denoising the media item (or features) to obtain a denoised media item. The forward diffusion process 1905 can be represented as q(xₜ|xₜ₋₁), and the reverse diffusion process 1910 can be represented as p(xₜ₋₁|xₜ). In some cases, the forward diffusion process 1905 is used during training to generate media items with successively greater noise, and a neural network is trained to perform the reverse diffusion process 1910 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{q} have the same dimensionality as x₀.

The neural network may be trained to perform the reverse process. During the reverse diffusion process 1910, the model begins with noisy data x_{T}, such as a noisy media item 1915 and denoises the data to obtain the p(xₜ₋₁|xₜ). At each step t−1, the reverse diffusion process 1910 takes xₜ, such as first intermediate media item 1920, and t as input. Here, t represents a step in the sequence of transitions associated with different noise levels, The reverse diffusion process 1910 outputs xₜ₋₁, such as second intermediate media item 1925 iteratively until x_{q} reverts back to x₀, the original media item 1930. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 12 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 13 )$$

where p(x_{T})=N(x_{T}; 0,1) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and x represents the generated item with high quality.

In FIGS. 12-19, an apparatus, system, and method for image generation are described. One or more embodiments of the apparatus, system, and method include a memory component; a processing device coupled to the memory component, the processing device configured to perform operations comprising; obtaining a concept input, a source image, and an input mask, wherein the concept input represents a concept, the source image depicts a scene, and the input mask indicates a location for the concept in the scene; generating concept features by performing a style transfer from the source image to the concept input based on the input mask; and generating, using an image generation model, a synthetic image based on the concept features, wherein the synthetic image depicts the concept from the concept input within the scene from the source image at the location indicated by the input mask.

In some examples, the image generation model comprises a diffusion U-Net. In some examples, the image generation model comprises a location adaptation module, a style adaptation module including an instance normalization component, a scale adaptation module, and a content adaptation module.

Some examples of the apparatus, system, and method further include generating, using a segmentation model, the input mask based on the source image and a text prompt, wherein the input mask is based on a region of an element described by the text prompt. Some examples of the apparatus, system, and method further include generating, using an inversion component, preliminary background features based on the source image.

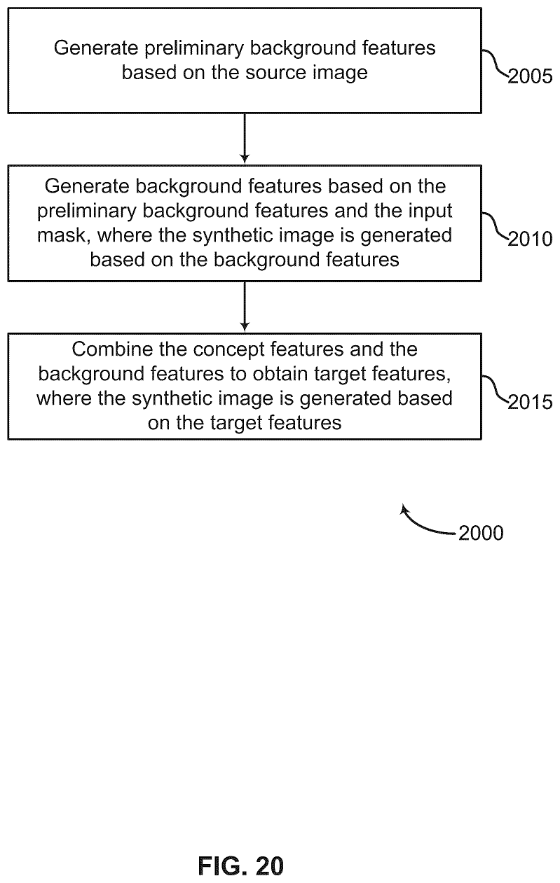

FIG. 20 shows an example of a method 2000 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 2005, the system generates preliminary background features based on the source image. In some cases, the operations of this step refer to, or may be performed by, an inversion component as described with reference to FIGS. 12 and 14.

At operation 2010, the system generates background features based on the preliminary background features and the input mask, where the synthetic image is generated based on the background features. In some cases, the operations of this step refer to, or may be performed by, a location adaptation module as described with reference to FIGS. 12 and 14.

At operation 2015, the system combines the concept features and the background features to obtain target features, where the synthetic image is generated based on the target features. In some cases, the operations of this step refer to, or may be performed by, a style adaptation module as described with reference to FIGS. 12 and 14.

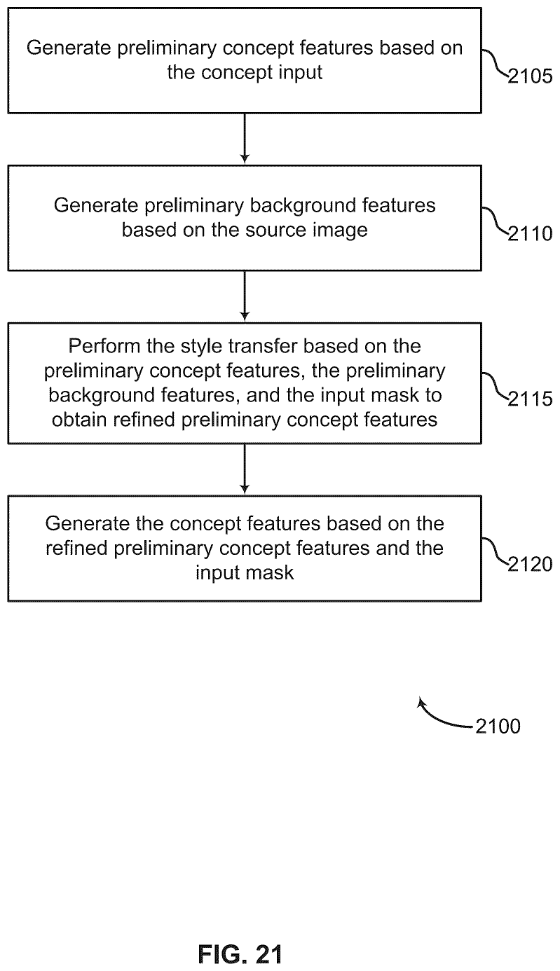

FIG. 21 shows an example of a method 2100 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 2105, the system generates preliminary concept features based on the concept input. In some cases, the operations of this step refer to, or may be performed by, a style adaptation module as described with reference to FIGS. 12 and 14.

At operation 2110, the system generates preliminary background features based on the source image. In some cases, the operations of this step refer to, or may be performed by, a style adaptation module as described with reference to FIGS. 12 and 14.

At operation 2115, the system performs the style transfer based on the preliminary concept features, the preliminary background features, and the input mask to obtain refined preliminary concept features. In some cases, the operations of this step refer to, or may be performed by, a style adaptation module as described with reference to FIGS. 12 and 14.

At operation 2120, the system generates the concept features based on the refined preliminary concept features and the input mask. In some cases, the operations of this step refer to, or may be performed by, a style adaptation module as described with reference to FIGS. 12 and 14.

FIG. 22 shows an example evaluation according to aspects of the present disclosure. The example shown includes concept input 2200, source image 2205, input mask 2210, and synthetic image 2215. As illustrated in FIG. 22, an input mask 2210 indicates the scale and location for the swapping in an object/concept from concept input 2200. The input mask 2210 indicates a location for the concept in the scene. Synthetic image 2215 depicts the concept input 2200 swapped into source image 2205 at the location indicated by input mask 2210.

In an example, concept input 2200 represents a “watch” concept/object. Source image 2205 depicts a wrist and a watch wrapped around the wrist. Input mask 2210 contains a masked area (white area in the shape of the watch) indicating a location for the concept in the scene of source image 2205. Synthetic image 2215 depicts the wrist from source image 2205 wearing the watch from concept input 2200 at the location of the original watch.

In some cases, concept input 2200 is reshaped to match the shape, size and scale of input mask 2210. In some cases, a smooth mask is used to create a feathering effect at the edge of the transition. The smooth mask provides a more natural blend between concept input 2200 and the scene of source image 2205.

Concept input 2200 is an example of, or includes aspects of, the corresponding element described with reference to FIGS. 3, 4, 7, 8, 10, 13, 14, and 23. Source image 2205 is an example of, or includes aspects of, the corresponding element described with reference to FIGS. 3, 4, 6-10, 13, 14, and 23. Input mask 2210 is an example of, or includes aspects of, the corresponding element described with reference to FIGS. 13-15. Synthetic image 2215 is an example of, or includes aspects of, the corresponding element described with reference to FIGS. 3, 4, 7-10, 13, 14, 16, and 23.

FIG. 23 shows an example of evaluation according to aspects of the present disclosure. The example shown includes concept input 2300, source image 2305, synthetic image 2310, and conventional results 2315. As illustrated in FIG. 23, object swapping according to aspects of the present disclosure provides high-quality images compared to conventional models. In one example, a concept input 2300 (a “raccoon” object) is swapped into source image 2305 (depicting a scene about a cat holding an umbrella) to generate synthetic image 2310 (a raccoon holding an umbrella). Compared to conventional results 2315 (with or without using a mask), synthetic image 2310 shows improvement on adapting the style, location, content, and scale of concept input 2300 to match the style of source image 2305.

Concept input 2300 is an example of, or includes aspects of, the corresponding element described with reference to FIGS. 3, 4, 7, 8, 10, 13, 14, and 22. Source image 2305 is an example of, or includes aspects of, the corresponding element described with reference to FIGS. 3, 4, 6-10, 13, 14, and 22. Synthetic image 2310 is an example of, or includes aspects of, the corresponding element described with reference to FIGS. 3, 4, 7-10, 13, 14, 16, and 22.

FIG. 24 shows an example of a method 2400 for training a diffusion model according to aspects of the present disclosure. In some embodiments, the method 2400 describes an operation of the training component 1265 described for configuring the image generation model 1225 as described with reference to FIG. 12. The method 2400 represents an example for training a reverse diffusion process as described above with reference to FIGS. 17 and 19. In some examples, these operations are performed by a system including a processor executing a set of codes to control functional elements of an apparatus, such as the guided latent diffusion model described in FIG. 17.

Additionally or alternatively, certain processes of method 2400 may be performed using special-purpose hardware. Generally, these operations are performed according to the methods and processes described in accordance with aspects of the present disclosure. In some cases, the operations described herein are composed of various substeps or are performed in conjunction with other operations.

At operation 2405, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 2410, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 2415, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 2420, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 2425, the system updates parameters of the model based on the comparison. For example, parameters of a U-Net may be updated using gradient descent. Time-dependent parameters of the Gaussian transitions can also be learned.

FIG. 25 shows an example of a step-by-step procedure for training a machine learning model according to aspects of the present disclosure. FIG. 25 shows an example of a step-by-step procedure for training a machine learning model according to aspects of the present disclosure. FIG. 25 shows a flow diagram depicting an algorithm as a step-by-step procedure 2500 in an example implementation of operations performable for training a machine-learning model. In some embodiments, the procedure 2500 describes an operation of the training component 1265 described for configuring the image generation model 1225 as described with reference to FIG. 12. The procedure 2500 provides one or more examples of generating training data, use of the training data to train a machine learning model, and use of the trained machine learning model to perform a task.

To begin in this example, a machine-learning system collects training data (block 2502) to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 2504) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 2506). Initialization of the machine-learning model includes selecting a model architecture (block 2508) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 2510). The loss function is utilized to measure a difference between an output of the machine-learning model (i.e., predictions) and target values (e.g., as expressed by the training data) to be used to train the machine-learning model. Additionally, an optimization algorithm is selected (2512) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 2514) examples of which includes initializing weights and biases of nodes to increase efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 2518) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 2520), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 2520), the procedure 2500 continues training of the machine-learning model using the training data (block 2518) in this example.

If the stopping criterion is met (“yes” from decision block 2520), the trained machine-learning model is then utilized to generate an output based on subsequent data (block 2522). The trained machine-learning model, for instance, is trained to perform a task as described above and therefore, once trained is configured to perform that task based on subsequent data received as an input and processed by the machine-learning model.

FIG. 26 shows an example of a computing device 2600 for image processing according to aspects of the present disclosure. The computing device 2600 may be an example of the image generation apparatus 1200 described with reference to FIG. 12. In one aspect, computing device 2600 includes processor(s) 2605, memory subsystem 2610, communication interface 2615, I/O interface 2620, user interface component(s) 2625, and channel 2630.

In some embodiments, computing device 2600 is an example of, or includes aspects of, the image generation model of FIG. 12. In some embodiments, computing device 2600 includes one or more processors 2605 that can execute instructions stored in memory subsystem 2610 to perform media generation.

According to some aspects, computing device 2600 includes one or more processors 2605. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 2610 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 2615 operates at a boundary between communicating entities (such as computing device 2600, one or more user devices, a cloud, and one or more databases) and channel 2630 and can record and process communications. In some cases, communication interface 2615 is provided to enable a processing system coupled to a transceiver (e.g., a transmitter and/or a receiver). In some examples, the transceiver is configured to transmit (or send) and receive signals for a communications device via an antenna.

According to some aspects, I/O interface 2620 is controlled by an I/O controller to manage input and output signals for computing device 2600. In some cases, I/O interface 2620 manages peripherals not integrated into computing device 2600. In some cases, I/O interface 2620 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2620 or via hardware components controlled by the I/O controller.

According to some aspects, user interface component(s) 2625 enable a user to interact with computing device 2600. In some cases, user interface component(s) 2625 include an audio device, such as an external speaker system, an external display device such as a display screen, an input device (e.g., a remote-control device interfaced with a user interface directly or through the I/O controller), or a combination thereof. In some cases, user interface component(s) 2625 include a GUI.

Performance of apparatus, systems and methods of the present disclosure have been evaluated, and results indicate embodiments of the present disclosure have obtained increased performance over conventional technology. Example experiments demonstrate that the image generation apparatus and machine learning model described in embodiments of the present disclosure outperforms conventional systems.

In some example experiments, human evaluation is considered the main quantitative performance measurement. A successful swap should keep the non-object area unchanged, change the object identity to target, and keep the gesture the same as the source object. The image generation model described in the present disclosure consistently outperforms baselines across all metrics, e.g., qualitative comparison for both human and non-human images. By adding targeting variable swapping and location adaptation (described with reference to FIGS. 13-15), attention-manipulation based baselines can achieve perfect background preservation and some level of localized swapping result. The image generation model described in the present disclosure yields better appearance adaptation results.

As shown in FIG. 5, multi-object swapping is achieved via repeating single-object swapping, which highlights its versatility and efficiency. Multi-object swapping is a natural outcome of the targeted variable swapping described in the present disclosure, whereas previous methods struggle to achieve satisfactory results. Without perfect context pixel preservation, the unwanted image modification would accumulate as the swapping continues.

As shown in FIG. 3 (2^{nd} row), the image generation model described in the present disclosure achieves a great performance when swapping a part of a whole object, even when the targeting area is very small. Other baselines failed to achieve such results.

FIG. 7 demonstrates that the image generation model described in the present disclosure can adeptly handle a range of stylized source images, successfully adapting concept objects to match the desired style within the source image while seamlessly transferring identity into the generated images. For example, when the source image is a photo of a certain style, the image generation model generates the same painting style featuring personalities like “Charles Darwin” and “J. Robert Oppenheimer”. Note the concept images are regular unstyled photos, underscoring the model's ability to blend different styles and identities effectively.

As shown in FIG. 9, besides personalized swapping, methods and apparatus described in the present disclosure can perform text-based swapping, swapping an object in the source image with another described in text. This is achieved by replacing the personalized concept token * with a text prompt, e.g., “A photo of new_obj”. The image generation model described in the present disclosure can be generalized for other tasks such as object insertion. With the same process as single object swapping, the image generation model inserts and adapts a concept into background pixels, while preserving the composition and style of the source image. As shown in FIG. 10, the image generation model inserts a puppy and a butterfly into The Starry Night painting from Vincent van Gogh.

The effect of components inside the image generation model has been studied (ablation study). In some examples, without latent feature swap, even with a mask and attention variable swap, the context pixel such as clothes is still changed. Both latent feature and attention variable has effect of information preservation when compared with the result of no swap. With style adaptation, the visual texture is closer to the source image. Without scale adaptation, the face shape is not well aligned and artifacts appear in the neck part. Without content adaptation, artifacts such as a hand touching the chin appear on the neck in the image. When without any adaptation, the generated image is much less connected the source image regarding the swapping area. When without mask, both background and targeting area are changed, which leads to a different image. Also, without the swapping and the adaptation described in the present disclosure, the edited image would have strong visual distortion after reshape to the size of source image.

The image generation model can be applied in the field of object swapping. Swapping latent features and attention variables in the diffusion model ensures the retention of important information within a synthetic image. Through targeted manipulation, optimal background preservation is achieved. Additionally, a sophisticated appearance adaptation process is implemented to seamlessly integrate the concept into the context of the source image. Therefore, the image generation model can handle a diverse array of object swapping tasks.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the concepts described. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The methods described may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a concept input, a source image, and an input mask, wherein the concept input represents a concept, the source image depicts a scene, and the input mask indicates a location for the concept in the scene;
generating concept features by performing a style transfer from the source image to the concept input based on the input mask; and
generating, using an image generation model, a synthetic image based on the concept features, wherein the synthetic image depicts the concept from the concept input within the scene from the source image at the location indicated by the input mask.

2. The method of claim 1, wherein obtaining the input mask comprises:
obtaining a text prompt describing an element of the source image; and
generating the input mask based on the source image and the text prompt, wherein the input mask is based on a region of the element described by the text prompt.

3. The method of claim 1, further comprising:
generating preliminary background features based on the source image; and
generating background features based on the preliminary background features and the input mask, wherein the synthetic image is generated based on the background features.

4. The method of claim 3, further comprising:
combining the concept features and the background features to obtain target features, wherein the synthetic image is generated based on the target features.

5. The method of claim 1, wherein generating the concept features comprises:
generating preliminary concept features based on the concept input;
generating preliminary background features based on the source image;
performing the style transfer based on the preliminary concept features, the preliminary background features, and the input mask to obtain refined preliminary concept features; and
generating the concept features based on the refined preliminary concept features and the input mask.

6. The method of claim 5, wherein:
the style transfer comprises a masked adaptive instance normalization.

7. The method of claim 1, further comprising:
identifying a shape of the concept using a cross-attention layer of the image generation model; and
computing shape guidance based on the shape and the input mask, wherein the synthetic image is generated based on the shape guidance.

8. The method of claim 1, further comprising:
performing boundary smoothing on the input mask to obtain a modified mask, wherein the concept features are generated based on the modified mask.

9. The method of claim 1, wherein generating the synthetic image comprises:
obtaining a noise map; and
denoising the noise map based on the concept features.

10. A non-transitory computer readable medium storing code for image processing, the code comprising instructions that, when executed by at least one processor, cause the at least one processor to perform operations comprising:
obtaining a concept input and a source image, wherein the concept input represents a concept and the source image depicts a scene;
generating concept features based on the concept input and the source image by performing a style transfer from the source image;
generating background features based on the source image; and
generating, using an image generation model, a synthetic image based on the concept features and the background features, wherein the synthetic image depicts the concept from the concept input within the scene from the source image.

11. The non-transitory computer readable medium of claim 10, wherein generating the concept features comprises:
generating preliminary concept features based on the concept input;
generating preliminary background features based on the source image; and
performing the style transfer based on the preliminary concept features and the preliminary background features, wherein the concept features based on the style transfer.

12. The non-transitory computer readable medium of claim 10, the code further comprising instructions executable by the at least one processor to perform operations comprising:
obtaining an input mask indicating a location for the concept in the scene.

13. The non-transitory computer readable medium of claim 12, wherein generating the background features comprises:
generating preliminary background features based on the source image; and
generating the background features based on the preliminary background features and the input mask, wherein the synthetic image is generated based on the background features.

14. The non-transitory computer readable medium of claim 12, the code further comprising instructions executable by the at least one processor to perform operations comprising:
identifying a shape of the concept using a cross-attention layer of the image generation model; and
computing shape guidance based on the shape and the input mask, wherein the synthetic image is generated based on the shape guidance.

15. The non-transitory computer readable medium of claim 10, the code further comprising instructions executable by the at least one processor to perform operations comprising:
combining the concept features and the background features to obtain target features, wherein the synthetic image is generated based on the target features.

16. A system comprising:
a memory component; and
a processing device coupled to the memory component, the processing device configured to perform operations comprising:
obtaining a concept input, a source image, and an input mask, wherein the concept input represents a concept, the source image depicts a scene, and the input mask indicates a location for the concept in the scene;
generating concept features by performing a style transfer from the source image to the concept input based on the input mask; and
generating, using an image generation model, a synthetic image based on the concept features, wherein the synthetic image depicts the concept from the concept input within the scene from the source image at the location indicated by the input mask.

17. The system of claim 16, wherein:
the image generation model comprises a diffusion U-Net.

18. The system of claim 16, wherein:
the image generation model comprises a location adaptation module, a style adaptation module including an instance normalization component, a scale adaptation module, and a content adaptation module.

19. The system of claim 16, wherein the processing device is further configured to perform operations comprising:
generating, using a segmentation model, the input mask based on the source image and a text prompt, wherein the input mask is based on a region of an element described by the text prompt.

20. The system of claim 16, wherein the processing device is further configured to perform operations comprising:
generating, using an inversion component, preliminary background features based on the source image.
